(19) United States
(12) Patent Application Publication
(10) Pub. No.: US 2004/0078276 A1
(43) Pub. Date: Apr. 22, 2004

(54) System for electronic merchandising and shopping

(76) Inventor: Kotaro Shimogori, Venice, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 09/747,454

(22) Filed: Dec. 22, 2000

(51) Int. Cl. G06F 17/60

(52) U.S. Cl. 705/26

(57) ABSTRACT

A network based merchandising system enabling electronic commerce which provides a full service e-commerce system for use by small and medium size businesses to enable them to provide an affordable, complete, real time, one stop, online credit/debit card processing, dynamic, transactional analysis, database management and a fully functional online shopping cart system for the merchant's customer database. The system includes a server computer, connected to a database at least one customer client computer and at least one vendor client computer all interconnected over the network. The server computer is programmed to enable the vendor, through a series of instructions, to set up a virtual store name including a predefined required designator all without the use of html or other programming language. A customer, through the customer client computer, may access the store and purchase goods by utilizing a merchant account credit card enabling portion of the system accessible to all vendors who subscribe to the system.

### FIELD OF THE INVENTION

The present invention relates to digital commerce and more particularly, to a shopping and merchandising system.

### Background of the Invention

It is very difficult and expensive for a small vendor or merchant to showcase its products for access by customers and to provide the ability for its customers to pay for purchases with a credit/debit card. The cost of the processing equipment and the service charges imposed by financial institutions for a credit card merchant account render it almost impossible for such small vendors or merchants to provide those services to their customers. In addition, the ability for the small vendor or merchant to have access to shelf space either in the merchants own store or in larger retail outlets is limited since such shelf space is normally provided to those products which achieve a rapid turnover. To achieve such rapid turnover requires that the products be heavily marketed, advertised and supported all of which reduce or eliminate the small merchant vendors access to market its goods as a result of the expenses associate therewith.

Even where credit card purchases are available, there may be fraud involved in that charges will be made against credit cards improperly and in some instances, the vendor/merchant will not ship the merchandise or will ship merchandise other than that which has been ordered and the user/purchaser is unable to obtain reimbursement of the finds spent or replacement of the merchandise with authentic merchandise as ordered.

With the advent of electronic transactions being conducted on the Internet, sellers and buyers can conduct commercial transactions without the need for physical shelf space. The global penetration of the Internet provides merchants with the capability to merchandise their products to substantial shopping audiences using an online merchant system. Such systems enable merchants to creatively display and describe their products to shoppers using web pages. These web pages have contents such as text, pictures, sound and video typically utilizing HyperText Markup Language (HTML). Shoppers utilizing the Internet, in turn, access a merchants web page using a browser installed on a client's personal computer connected to the Internet through an online service provider. The browser interprets the HTML to format and display the merchants page for the shopper. The online merchant system likewise enables shoppers to browse through a merchant's store to identify products of interest, to obtain specific product information and to electronically purchase products after reviewing product information. To complete a purchase transaction, the merchant sums up the prices of items, deducts applicable discounts, calculates sales taxes, receives payment and delivers the purchased item to the shopper. Typically, merchants have to include a shipping and handling fee for their online shoppers and may have to include special taxes or fees such as value added taxes or user fees applicable only in certain countries or economic unions. In addition, arrangements have to be made to provide for payment by the customer to the merchant. This may be done by the merchant issuing special credit or charge cards to their customers or allowing the customers to utilize bank issued credit cards. The merchant must also purchase gateway software and shopping cart technology to enable his site to transact real time credit card charges. Thus, it becomes apparent that to enter the online shopping market merchants require an online system that provides for substantial variations in the purchase transaction model as well as a system which includes databases having product data such as descriptions, prices, pictures and the like stored in appropriate databases according to a predetermined format acceptable to the various database management systems. For a merchant to provide such an online web page requires retention of specialists to design and maintain the web page which is quite expensive and is an ongoing expense.

Another problem which exists in conducting electronic commerce over a public network such as the Internet, is the lack of a secure means for transferring money. When making a purchase, the customer generally must transmit his/her credit card number and other confidential information electronically to the merchant. Such information is at risk of interception by third parties or misuse by employees of the merchant. Although some web browsers permit data encryption, the effectiveness of such encryption generally is limited.

In addition to the foregoing, when a customer is attempting to conduct electronic commerce over the Internet, the customer generally must type in and transmit a large amount of information including confidential financial information each time the customer wishes to purchase something from a merchant and particularly if the customer goes from one merchant to another. The type and form of such information varies from merchant to merchant and each merchant typically has a customized electronic order form which the customer must complete to make a purchase. This turns out to be very burdensome for the customer and it also requires the customer's confidential information to be placed at risk each time such information is transmitted to a new merchant.

Another problem with commerce over the Internet is the lack of standards and integration for conducting digital commerce. Thus, if the merchant does not conform its database, assuming the merchant has a database, in accordance with a predetermined format acceptable for database management systems, creating a “virtual store” often is expensive and time consuming because merchants must create custom systems for selling their merchandise and making sure they obtain adequate information and payment from customers. In many cases, small merchants or vendors do not have the capability (technical knowledge) to or the finances to hire adequately trained persons to create the custom system needed for displaying their products on a website accessible to the electronic commerce customer.

Accordingly, there is a need for a full service e-commerce enablement system for small and medium size businesses to enable them to provide an affordable, complete real time, one stop online credit/debit card processing, dynamic transactional analysis database management and a fully functional online shopping cart system for the merchant's customer base.

### SUMMARY OF THE INVENTION

A network based merchandising system for enabling electronic commerce between merchants(vendor) and customers (customer) including at least one vendor client computer and at least one customer client computer, a server computer, and a database. Means for providing access by said vendor client computer through said server computer to said database. Said server computer programmed to provide a plurality of instructions to said vendor client computer enabling said vendor through said vendor client computer to set up a virtual store including a display of the merchant's products. Said server computer being further programmed to enable the vendor through the vendor client computer to select and adopt a unique domain name having a preset required designator and resident only on said database. The system further includes means for said customer through said customer client computer to access said merchant's virtual store resident on said database by inputting said unique domain name. Said network further comprising means permitting said customer through said customer client computer to purchase products from said merchant.

### BRIEF DESCRIPTION OF THE DRAWINGS

FIG. 1 is a schematic diagram illustrative of the overall network based merchandising system of the present invention;

FIG. 2 is a schematic diagram illustrative of the store set up by the vendor;

FIG. 3 is a schematic diagram illustrative of the fact that the user once logged into the system may access any merchant on the system without providing further information;

FIG. 4 is a schematic diagram illustrating access of the small merchant to the network;

FIG. 5 is a schematic diagram illustrative of the merchants initial registration;

FIG. 6 is a schematic diagram of the steps involved by the merchant in setting up the store;

FIG. 7 is a schematic diagram illustrating establishing billing and payment methods by the merchant;

FIG. 8 is a schematic diagram illustrating the ability for the merchant to upload images to the network database for use in creating the store;

FIG. 9 is a schematic diagram of the steps used by the vendor in building a store;

FIG. 10 is a schematic diagram illustrative of various reports which with the network system may generate for the merchant;

FIG. 11 is a schematic diagram illustrative of a purchase of products by the customer;

FIG. 12 is a schematic diagram illustrative of the stores display of information about the store which may be useful to the customer;

FIG. 13 is a schematic diagram illustrative of the ability for the customer to search the store database to determine previous readings;

FIG. 14 is a schematic diagram illustrative of a customers log in to the merchant store;

FIG. 15 is a schematic diagram illustrative of the verification of product shipment and payment;

FIG. 16 is a schematic diagram illustrative of a purchase by a customer and payment utilizing other than a credit card;

FIG. 17 is a schematic diagram illustrative of the customers ability to rate a store;

FIG. 18 is a schematic diagram illustrative of the network system of the present invention being mirrored;

FIG. 19 is a schematic diagram illustrative of the ability for a customer to utilize a credit card at a physical location without logging into the network;

FIG. 20 is a schematic diagram illustrative of the ability of the customer to select a store by category; and

FIG. 21 is a schematic diagram of the network based merchandising system in accordance with the present invention.

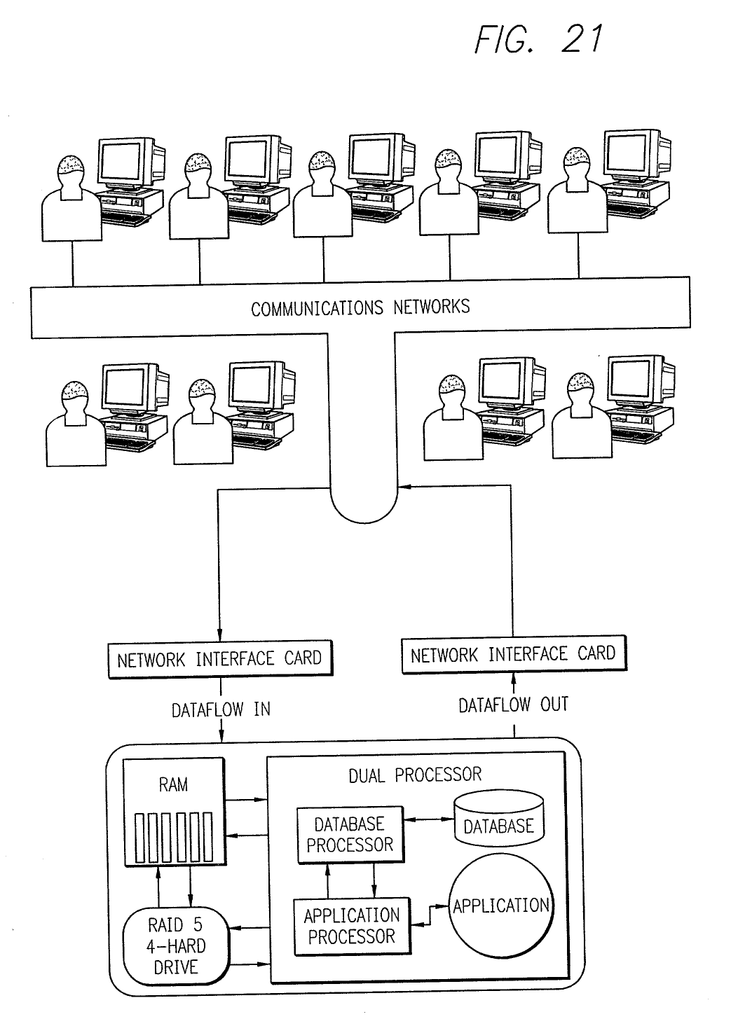

### DETAILED DESCRIPTION

In some portions of the world it is very difficult and expensive for a merchant to provide the ability for its customers to pay for purchases with a credit/debit card. The cost of the processing equipment and the service charges imposed by financial institutions for a credit card merchant account render it almost impossible for small companies to provide onsite credit card purchasing service to their customers.

It is the purpose of the present invention to provide a full service e-commerce enablement system for small and medium size businesses to enable them to provide an affordable, complete, real time, one-stop, online, credit/debit card processing, dynamic transactional analysis, database management, and a fully functional online shopping cart system for the merchant's customer base. The system provides a secure means for preventing fraud through the use of default e-mails to the customer and precluding transfer of funds until the transaction has been satisfactorily consummated.

The following description will be given with respect to a single merchant however, it will be recognized by those skilled in the art that there will be a large multiplicity of vendor users (merchants) who will subscribe to the system. The intent is to identify each of those vendors and provide them with a visual symbol which can be displayed in their brick and mortar stores so that their customers will recognize the fact that particular user vendor has subscribed to the system constructed in accordance with the present invention. It should be recognized that the system of the present invention may be used by a vendor whether or not a brick and mortar store. This enables the user vendor's customer base to access the web site virtual store of that merchant and conduct e-commerce utilizing his or her credit/debit card (irrespective of who has issued it) in the process. The system designed in accordance with the present invention may have any name desired, however, the inventor has chosen the name OKAIKEI and that term will be used throughout the remainder of the application. That name has been chosen because it is the Japanese word for “to check out” and the initial system is designed specifically for use in the Japanese economy.

The Okaikei server computer may be accessed by a vendor through the vendor's personal computer and when such is done, the Okaikei server computer is programmed to produce a registration process on the vendor's personal computer (PC) screen. The vendor will first select a desired store name and then proceed to the registration process. This will require the vendor to enter its name, address, category of products and other information which appears on the registration form. Registration by the vendor of its own unique Uniform Resource Locator (URL) will be accomplished through the Okaikei system and, for example, the URL will normally read “YOUR STORE NAME.OKAIKEI.com”. Since all of the URL's registered through Okaikei will contain the preset required designator OKAIKEI.com, the unique identifiers will in all cases be the name of the store of the vendor which name is known by the vendor's customer base. Once the vendor is satisfied with the URL and agrees to it, a fee will be charged to the vendor for registering and maintaining that URL for that store. It is to be recognized that this is not a URL in the common sense of those registered by Network Solutions Inc. or ICANN, but rather, is a URL unique to and limited to the OKAIKEI system and resident only on the OKAIKEI database. The OKAIKEI term should be understood to be a preset required designator for the particular system being used and may be any term desired. The vendor must use that term as part of the URL and the server computer will require its use. That preset required designator may be viewed as the second level domain name. The second level domain name OKAIKEI is registered through ICANN and/or other appropriate registrars, when the customer logs on and includes “OKAIKEI.com” in the URL, it will be directed to the OKAIKEI system where the server computer is programmed to search for the “YOURSTORENAME” on the OKAIKEI database. The “YOURSTORENAME” may be viewed as a third level domain name in the context of the present invention.

The Okaikei server computer is programmed to then take the vendor through a series of steps allowing the vendor to create its own virtual store without the vendor having any knowledge of HTML or other such languages which is usually required to build web sites. This will include selecting the layout of the store as it will appear on the computer screen, including background color and decoration, with the various products positioned in various positions and places as desired by the vendor. The store can also be setup in such a way that it includes various comments about the vendor, about the vendor policies, about the manager, including any images, trademarks other promotional materials and the like which is desired. Upon completion of the store, the products may also be viewed by the customer in various manners such as viewing all of the products in a single table with thumbnail images of the products, or products on a category basis, or individually, or the like. The provision for the customer to obtain a shopping cart and the like will be available. The store may also convey various other information such as product variations (i.e., color and size) payment methods, shipping methods, prices, return policies, and the like. When the store has been completed and the vendor so designates and clicks on the completion satisfied button available on his screen then the information will be entered into the Okaikei database and the vendor's virtual store will be available to user purchasers who wish to purchase the goods of the vendor/merchant. The vendor may from time to time edit the store, change positions of the various goods, delete goods, add goods and highlight featured products that will show as the preferred item to the customers when they log into the completed store.

The customer may, after accessing the Okaikei server, by simply typing in the name of the store, immediately access the store without going through any of the direct Okaikei materials. The user need not subscribe, pay any fee or in any way register with Okaikei to be able to log into the store. It is exactly the same as utilizing the Internet to log into any website that is available to the public. They would merely need to type in the name of the vendor plus Okaikei.com to gain immediate access to the vendor's virtual store. After the customer does access the desired virtual store, the user may browse through the store by scrolling through the page as it appears or may go from page to page if there are different pages for the virtual store for that vendor. If the customer wishes to purchase any of the goods, the customer would then click on to those goods, obtain a shopping cart and place the goods into the shopping cart. If the customer wishes to pay for the goods which are being purchased by credit card, which will be the usual type of situation, the customer would then of course, have to provide his/her credit card information to pay for the goods. Many customers are concerned about transmitting their credit card information over the internet and sharing it with merchants and personnel working for the merchant. The system of the present invention receives the customer credit card information and retains it in the database in a secure manner such that it is not accessible by the merchant or others. At this point, the credit card is merely authorized and that information would go into the Okaikei payment system and be recorded in the Okaikei database. Thereafter, the vendor checks the orders, assures that the goods are in inventory, authorizes the charge tot he customers credit card and ships the purchased goods to the customer. To enable the vendor to accept credit/debit cards as a means for the customer to pay for the purchased goods, the vendor must have access to a merchant credit card account authorized by an appropriate financial institution. The system of the present invention includes as a material part thereof such a merchant account underwritten by an appropriate financial institution such as a bank. Each vendor subscriber to the Okaikei system has access to that merchant account and all credit card transactions are processed through it by the underwriting bank without further cost to the vendor other than the normal transaction service provider fees agreed to by the vendor at the time of subscribing. In this manner, the small business operator has access to credit card transactions without the attendant high costs normally associated therewith.

At the time of the purchase, the customer is notified that there will be a period of time within which the user can notify the Okaikei system that he/she has received the goods and that the goods are satisfactory. If the customer does indicate that the goods have been received and that they are satisfactory then the Okaikei system will automatically signal that the transaction has been completed. In addition, the customer is notified by e-mail that a specific period exists during which the customer may submit a complaint about the goods or return the goods and void the purchase. This may be anytime desired but typically will be thirty (30) days. Alternatively, if the customer does not indicate receipt or does not void the transaction, i.e. does nothing, the server is programmed to provide appropriate e-mail notices to the customer. Typically, the customer receives two such notices requesting a response. After the second and final notice, the customer is notified that the transaction has been deemed completed through failure on the customers part to respond. Once the transaction has been completed the Okaikei system will then credit the vendor by transferring the funds to the vendor.

It is anticipated that there will be numerous small businesses which will become subscribers to the Okaikei system as generally outlined above. The brick and mortar stores will have a symbol that will be provided to them for posting in their brick and mortar business place. Once a customer logs into an Okaikei certified store and provides his/her credit card information and is accepted as a valid purchaser, then that customer may gain access to the Okaikei database through the server as shown and thus may access any of the stores of the various subscribers and shop in any of those stores.

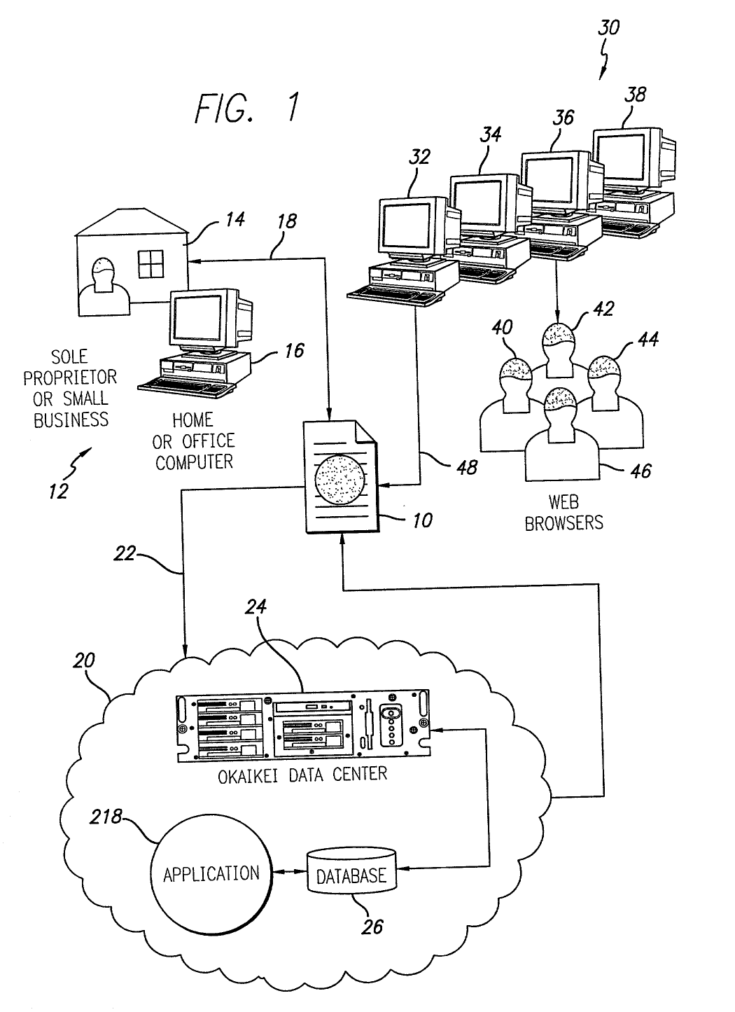

By reference now to FIG. 1 there is illustrated generally the Okaikei e-commerce system in schematic format. As is shown generally, the requirement is an ability to communicate over a network such as the worldwide web or Internet which is illustrated generally at 10. A vendor merchant 12 typically of a small or medium size type of business may have a typical brick and mortar operation 14 within which is sold that merchants products. It should be recognized that a vendor may subscribe and use the Okaikei system without having a brick and mortar facility. Included within the small business 12 will be a personal vendor client computer 16 of the type which is well known in the industry. The vendor client computer 16 must be capable of accessing the Internet 10 as is illustrated by the connection 18 thereto. Obviously, the connection 18 may be (POTS) plain old telephone system or alternatively, may be a wireless communication link. The Okaikei system of the present invention is Wireless Application Protocol (WAP) enabled. Thus, the merchant 12 or the consumers, as will be more fully discussed below, may access the Okaikei system through the use of wireless technology.

The Okaikei system includes a data center 20 which is accessible through the Internet 10 as is indicated by the communication link 22 connected therewith. The data center 20 includes a server computer 24 which in turn, is connected to a database 26 which is capable of running various applications as indicated at 28. The server computer 24 may be any known to the art which will provide the connection and facility needed for the Okaikei system. However, in accordance with a preferred embodiment, the server computer 24 is currently built on a NT system using Microsoft SQL server 7.00 as the database server and Coldfusion running the web application. The specification on the server is 933 MHz dual processor, 1 GIG of RAM, RAID (4-36 GB 10 k RPM SCSI hard drives) and HOT swappable power supply.

As indicated generally above, various consumers wishing to conduct e-commerce with various merchants such as the merchant shown at 12 are illustrated at 30. Each of these consumers will have his or her own individual personal consumer client computer as represented at 32,34,36 and 38. Each of these consumer client computers 32-38 will have its own individual web browser as is indicated at 40, 42, 44 and 46. Each of the web browsers will be capable of communicating with the internet 10 as indicated by the communication link 48.

Once the small business vendor 12 has access to the Okaikei data center and established its virtual store, as will be described in detail below, then the consumers may through the utilization of the web browsers access the Okaikei system and in turn, access the small business vendor unique web site housed on the Okaikei database 26 and conduct e-commerce as desired.

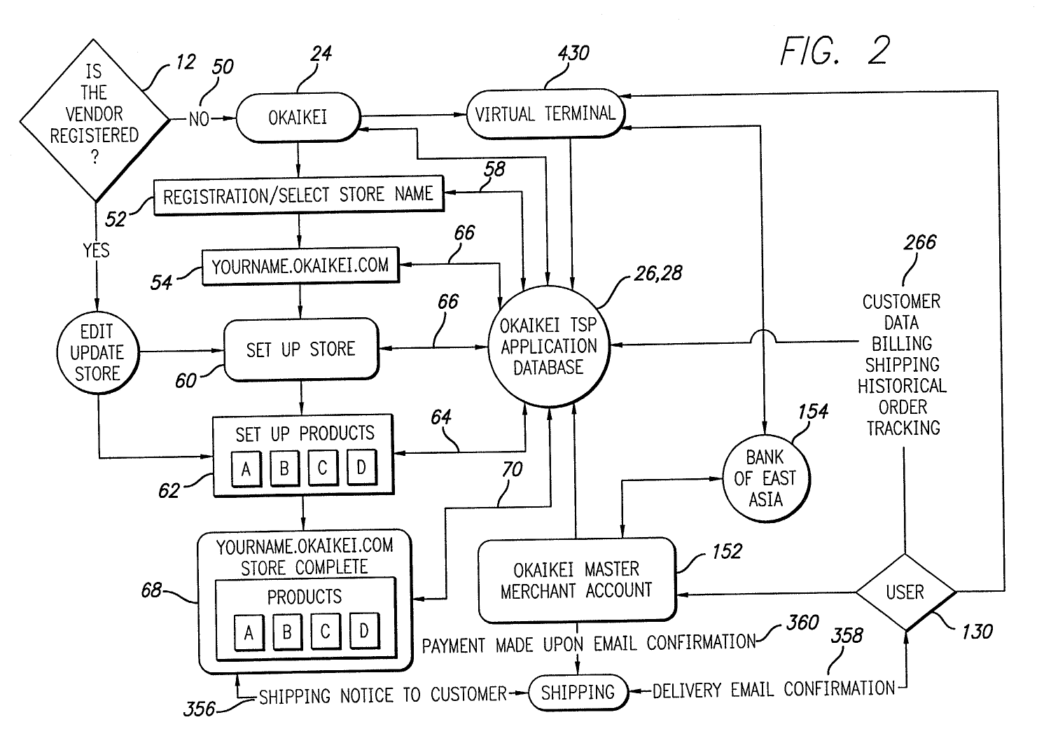

By reference now to FIG. 2, the Okaikei system is illustrated in slightly more detail. As is therein illustrated, the Okaikei system which includes the computer server 24 and the application database 26, 28 is accessible by the vendor 12 and by the customers 30 through the utilization of the Internet. Once the vendor has established communication with the server computer 24, the server computer is programmed to query the database 26, 28 to determine whether or not that vendor 12 is registered with the Okaikei system. If the vendor is not registered as is indicated at 50 then the system is programmed to provide to the vendor client computer, a registration sequence which will include the selection of a store name as shown at 52 which upon approval, is converted into a URL as shown at 54 which is stored in the Okaikei database as shown at 56. As the vendor 12 responds to the queries generated by the computer program and attempts to select a store name as shown at 52, the selected name will be transmitted as shown at 58 to the database 26, 28 to determine whether or not that name is available and can be appropriated for use by the vendor 12. As above indicated, when the name has been approved, then it will be converted into the URL which typically will be the name of the vendor's store and will conclude in all cases with the preset required designator applicable to the particular system and in this case, will be Okaikei.com.

Once the name has been selected and the URL generated, then the server computer 24 with the database is programmed to provide a series of prompts and queries as shown at 60 to enable the vendor to set up its virtual store. In accomplishing the store setup the vendor will setup various products such as providing photographs, descriptions, specifications and the like as indicated at A, B, C and D within the setup products block 62. Once these products have been setup, such will be communicated to the database as shown at 64 thus, completing the setup of the store as shown at 66. The store bearing the name of “your name.Okaikei.com” when completed will be displayed on the vendor's PC screen as illustrated generally at 68 showing the setup of the store along with the various products A, B, C and D as selected by the vendor 12 in response to the computer program resident in the Okaikei data center 20. This final complete store set up is also communicated as shown at 70 to the Okaikei database and is now resident thereon for access by the customers 30.

To provide to the vendor the ability to accept credit card payments, the Okaikei system includes as an integral part thereof, a merchant account 152. Anyone of a various number of merchant accounts may be used depending upon the application such as a master merchant account or a standard merchant account. This account is provided by way of contracting with a financial institution 154 such as the Bank of East Asia (BEA). BEA underwrites the credit card transactions and through the merchant account, processes the credit card transaction by obtaining authorization from the credit card issuer to charge the credit card for the amount of the purchase. Each of the vendors 12, after appropriate registration, has access through the server computer 24 and the database 26, 28 and the merchant account 152 to allow its customers to charge their purchases by credit/debit card. Other than the payment of the discount rate, subscription fee and a transaction fee, the vendor has no additional charge for the credit card merchant account. This places the ability to use credit card purchases well within the reach of the small business.

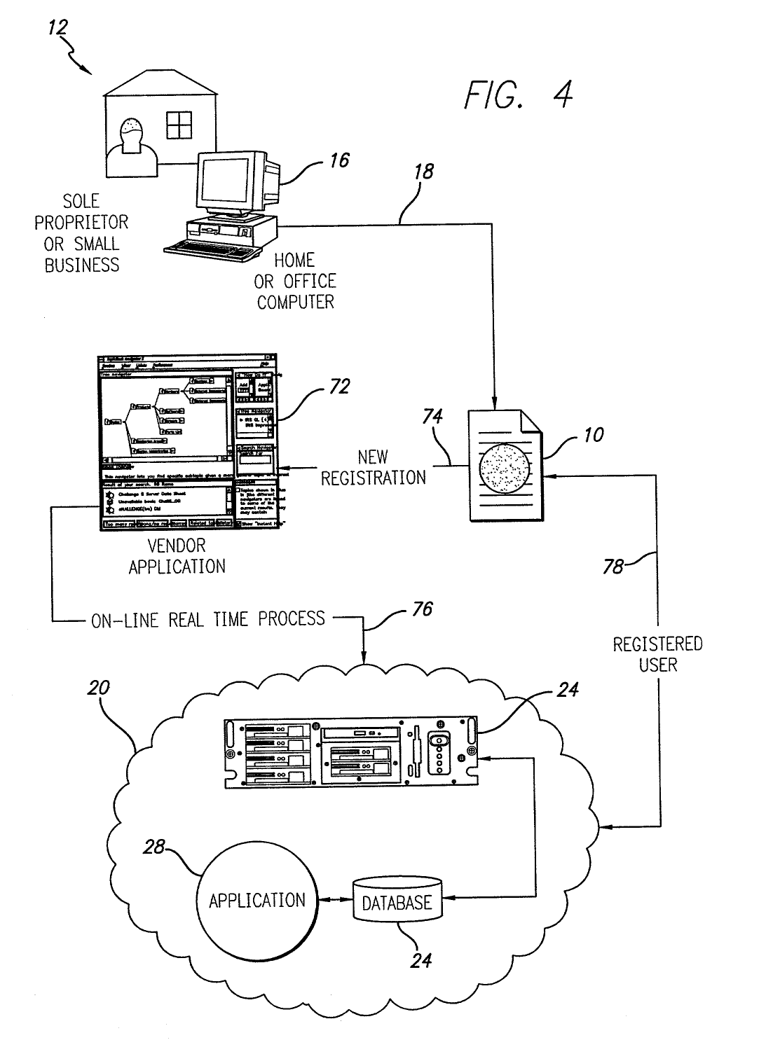

As is shown generally at FIG. 4, when the small business vendor 12 accesses the Internet 10 through its computer 16 and is found not to be a registered user/vendor then the vendor application 72 is retrieved from the database 26, 28 by way of the programmed server computer 24 as is illustrated by the communication links 74 and 76 with the Okaikei data center 20. In the event that the vendor 12 has already been registered then it will be identified as a registered vendor user as shown by the communication link 78 and will enable the vendor user to conduct various operations with regard to its virtual store as set up on the Okaikei system as will be described more fully below.

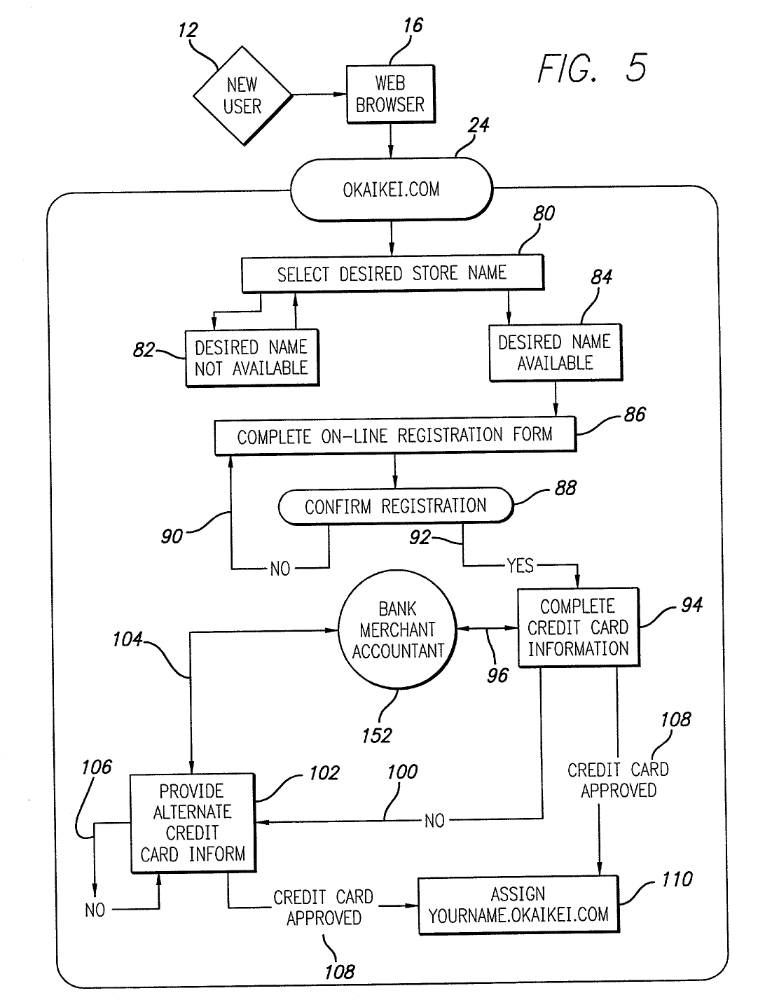

As is illustrated in FIG. 5 in greater detail, when the new vendor 12, through its web browser on its vendor client computer 16, contacts and is connected to the Okaikei system server computer 24 to complete its registration, the first step in registration is to select a desired store name as is shown at 80. Upon entry of the desired store name, which will typically be the vendor 12 store name, the Okaikei system database will be searched to determine whether or not the name is available. If it is determined as illustrated at 82 that the name is not available, then that information will be communicated back to the vendor with a prompt to select a different desired store name since the first one was not available. If on the other hand, the desired name is available as shown at 84, then the computer program provides a prompt to the merchant 12 to complete in on-line registration form as is shown at 86. The registration form will request the merchants detailed information such as name, address, type of store, contact information, name of manager, various store departments category of products and the like. The information required and entered will depend upon the particular type of store and the amount of detail desired to be entered by the merchant in each case. Once the information is entered, a query will be given to the merchant as shown at 88 that enables the merchant to confirm the registration. If the registration is not to be confirmed, then such is communicated as indicated at 90 and the merchant is given further opportunity to complete or edit the online registration form. Once the registration has been confirmed as indicated by the communication 92, the vendor is required as shown at 94 to complete its credit card information. The credit card information is typically the credit/debit card utilized by the vendor 12 for payment of that vendor's debts. Once the credit card information has been completed at 94, it will be transmitted as shown at 96 to the bank merchant account 152. The BEA will then query the credit card issuer which is usually the bank which handles the transactions for that particular vendor. The vendor's bank will after appropriate analysis and checking approve or disapprove that particular vendor's credit/debit card information which has been provided in response to the computer programmed prompt as shown at 94. If the credit card information originally provided is inadequate and is not complete, as indicated at 100 then a prompt will be entered as shown at 102 to provide alternate credit card information. Such information is also transmitted as shown by the communication link 104 to the bank handling that vendor's account for consideration and approval. As illustrated by the link 106, additional credit card information may from time-to-time be required.

Upon approval by the vendor's bank of the credit card as shown at 108, that will complete i-he registration for that new vendor 12 and the server computer is programmed as illustrated at 110 to assign the selected store name to that vendor which as indicated, will be in the form “yourname.Okaikei.com” which will constitute the URL on the Okaikei database for that new vendor user 12. The server computer 24 is programmed so that if during the registration procedure, the vendor fails to insert information in a field or incorrectly inserts information, a prompt appears on the computer screen telling the vendor specifically what to do. This type of detailed instruction makes it extremely easy for the vendor to use this system even if he/she has little or no computer use experience.

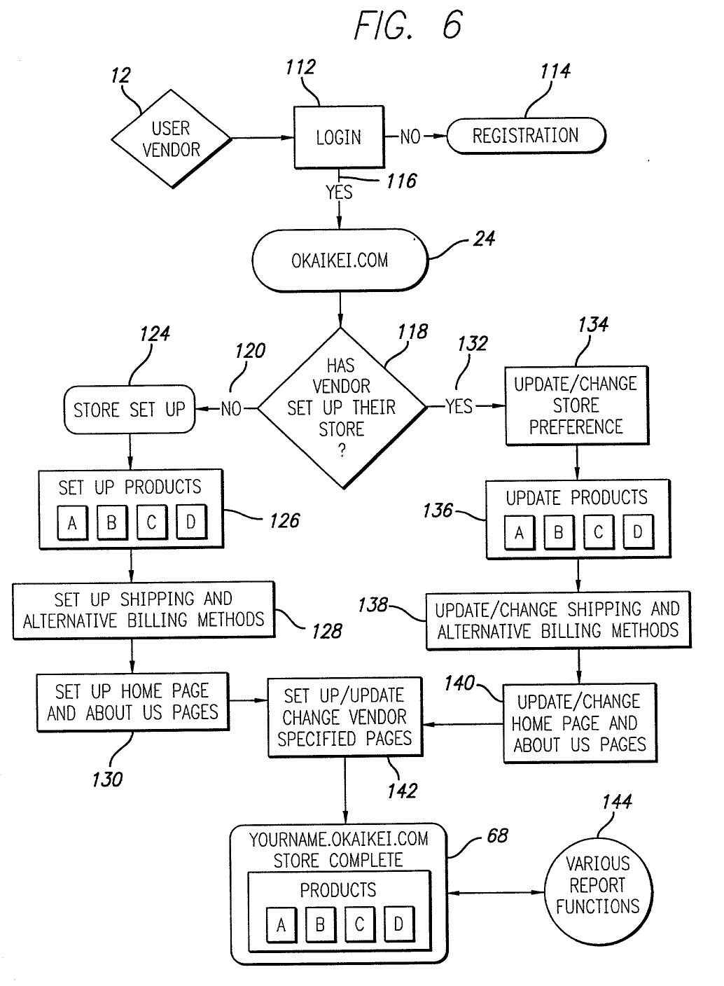

Once the new user vendor has completed its registration and has been assigned its URL as above described, it may as above referred to in the discussion of the system as schematically illustrated in FIG. 2 set up the store as shown at 60. This can be accomplished immediately subsequent to the online registration or alternatively, during a subsequent log-in session as may be desired. Such is illustrated in FIG. 6 to which reference is hereby made. As is therein shown, the user vendor logs in as illustrated at 112. If the user/vendor 12 has not registered, it will be referred to the registration procedure 114 as above described in conjunction with the illustration of the system as shown at FIG. 5. If registration has occurred as indicated at 116, then the user is connected to the Okaikei system as shown at 24. The server computer is programmed to display to the user 12 a query as shown at 118 as to whether or not the vendor user 12 has set up its store. If the vendor has not set up the store as indicated at 120, then the store set up procedure as shown at 124 will be displayed on the vendor client computer. The server computer 24 is programmed to provide a series of areas which may be utilized by the vendor in setting up the store. These areas will include such items as the store layout, that is, the positions where the various shelves will appear, what appears on a particular page insofar as the store layout is concerned, where various products may appear, the desired background color, graphics and the like. When the store setup 124 is clicked on, it will cause as a result of the computer program on the server computer to provide a PDF instruction for download by the vendor which includes step by step instructions on how and what is needed to create the virtual store. These instructions like those provided during the registration procedure, clearly tell the vendor what should be entered and how it should be entered. If the vendor does not complete a particular section or do so improperly, prompts will appear to assist the vendor in completing the store setup. In the alternative, the server computer 24 is programmed to provide a default store layout which may be accepted by the vendor. This stop makes it much easier for the vendor to set up the virtual store. All the vendor needs to do after acceptance of the default store layout is to add products.

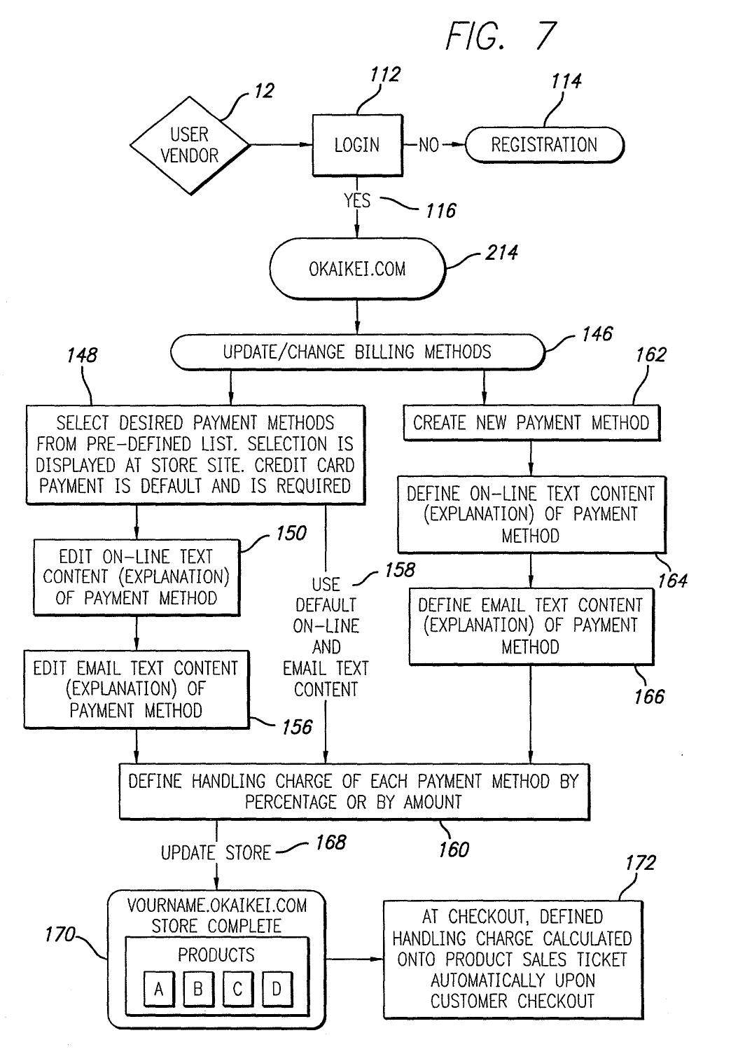

One of the series of prompts appearing on the user/vendor's PC screen as programmed by the Okaikei system server computer 24 is to enable the user to choose its products as shown at 126. As above described, the user/vendor 12 may choose any products desired such as those illustrated schematically at A, B, C and D and to provide any type of images, descriptions, or other information as may be desired by the user/vendor 12 to convey to a customer the attributes of the products which the customer may desire to purchase. After the set up of the products has occurred and such has been approved by the vendor 12, the user/vendor 12 will then be prompted by the computer program to establish its shipping and alternative billing methods, if any. As is illustrated at 128, preferably the billing methods will be by way of a credit card but as will be discussed in more detail below in conjunction with FIG. 7 alternative types of payments may be accepted by the user/vendor 12 in the event its customers do not have approved credit cards. The system is programmed to provide default text to the vendor which may be used, if desired. Alternatively, the vendor may customize the text. After setting up the shipping and alternative billing methods, the user/vendor 12 is then instructed as shown at 130 to set up the “home page” and the “about us” pages which will be desired by the user/vendor to convey the desired messages to its customer base about its capabilities.

In the event that the vendor has already set up its store as indicated at 132, the vendor will then be provided an opportunity as shown at 134 to update or change the store if it desires to do so. That is, the vendor/user may by merely providing instructions to the Okaikei server 24 change the layout of the store by moving various portions thereof from one area to another, delete or add aspects of the store as may be desired. Thereafter, the vendor 12 as shown at 136 will be prompted to update its products as it may desire. At this time, the user may eliminate one of the products, may add products, may provide new specifications or advertising material about the products already in existence or the like. After updating the products, the shipping and alternative billing methods may be updated as shown at 138. Thereafter, as shown at 140 the vendor may update or change the “home page” and the “about us” pages.

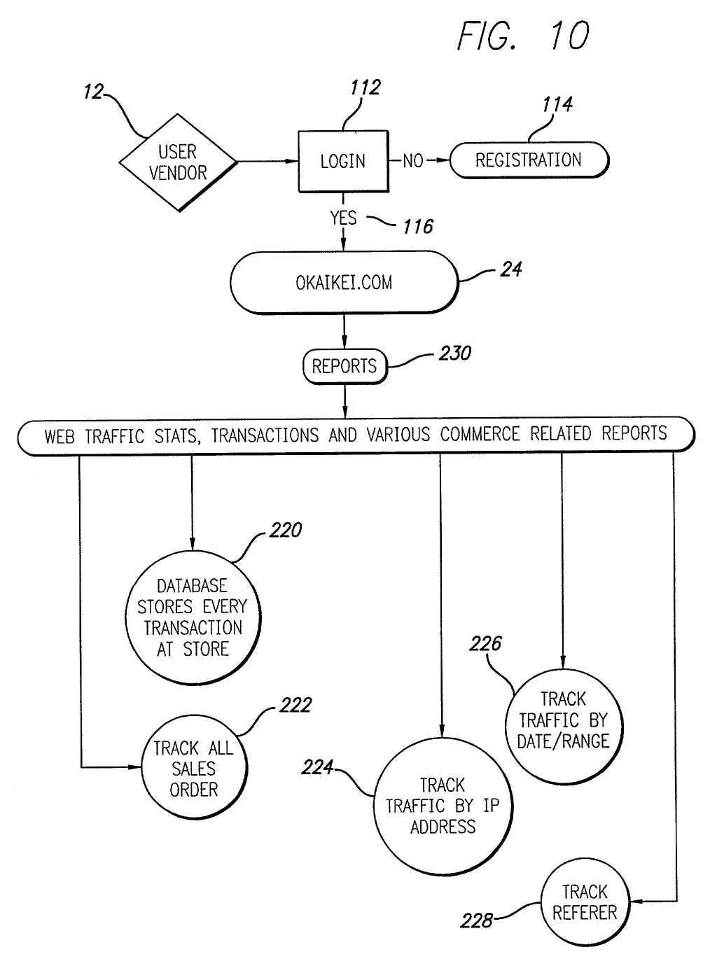

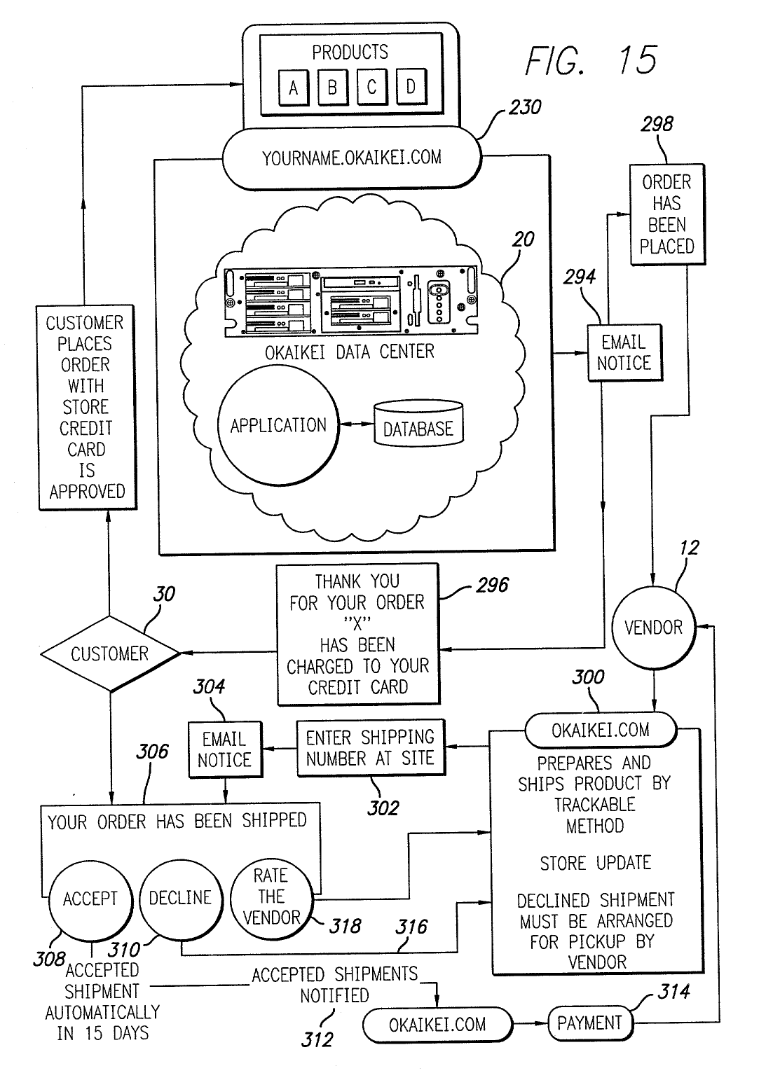

After the various set ups, in the event such occurs, or the changes, in the event such occurs are completed, they will then be provided to the system as shown at 142 and upon approval by the vendor, will then be illustrated as the completed store 68 bearing the URL “yourname.Okaikei.com” as above described in conjunction with FIG. 2. As is illustrated generally at 144 the server computer 24 and the database 26, 28 is programmed to provide to the vendor 12 various reports as may be requested by the vendor concerning the web traffic, various consumer transactions, consumer satisfaction and the like. Such will be discussed more fully hereinafter in conjunction with FIGS. 10 and 15.

During the store set up as above described in conjunction with FIG. 6, the vendor 12 may at the time of the set up, receive a shipping and alternative billing methods prompt as shown at 128. Clicking on that prompt will result in the vendor immediately receiving as a result of the computer program resident on the server a series of prompts enabling the merchant to set up the alternative billing methods and the desired shipping procedures which that merchant desires to utilize. Alternatively, the merchant may defer until the completion of the store set up has occurred in order to select the desired billing and shipping methods. This is illustrated in FIG. 7 to which reference is hereby made.

As is therein shown, the user/vendor 12 may log-in as shown at 112 and again, the system will be queried as to whether or not registration has occurred and, if such has not occurred, then the registration procedure will be displayed to the vendor. If, however, such registration has occurred as shown at 116, then the vendor will be immediately connected to the Okaikei system and the server computer as shown at 24. Since the vendor is now selecting the setup shipping and alternative billing methods portion of the program, it will be provided by way of the programmed server computer 24 with a series of instructions and queries to select a billing method or to update or change the billing method as is illustrated at 146. The computer program resident in the server computer 24 will present a predefined or default list of payment methods which the merchant user/vendor 12 may select from as is shown at 148. As is indicated, the utilization of a credit card in order to pay for the goods which have been selected by the customer is the preferred and default method of payment and the user/vendor 12 must select at least this type of payment in all cases. Other types of payments may also be selected such as convenience store, direct bank deposit, wire transfers, postal service deposit or C.O.D. service. This portion of the Okaikei system is established such that the consumer may choose an alternate form of payment if the consumer desires to do so. It should be recognized that the vendor selects the type of payment method(s) that it will accept. Obviously, the customer may preview this page prior to making any purchases. When the consumer clicks on the alternate form of payment, the various forms as above outlined will be displayed on the consumer client computer screen and the consumer will then choose the desired form of payment other than the credit card.

As is shown at 150, the merchant/vendor 12 may provide an explanation of the payment method in an online text content format which will be displayed to the consumer. The explanation of the payment method can be based upon the utilization of the credit card or any one of the alternative methods of payment as above set forth. As will be described more in detail below when a credit card is utilized to make the payment for the product chosen, an e-mail will be sent immediately to the consumer thanking the consumer for the order and informing the consumer that his or her credit card will be charged for the amount of the value of the order upon confirmation of inventory and delivery of product. The credit card charge will then be processed through the Okaikei merchant account 152 as shown in FIG. 2 and as underwritten by a financial institution such as a bank 154 or the like which is contracting with the Okaikei system.

Alternatively, if the consumer chooses one of the alternative payment methods which has been provided by the vendor 12, then the vendor must provide the explanations as to how the payment must be made in order to be acceptable to the vendor. Alternatively, the vendor may choose default text explanations which have been programmed into the system for ease of use by the vendor. The actual payments when they are non-credit card will be handled exclusively by the vendor 12 directly and a separate e-mail will be provided to the consumer as shown at 156 explaining the payment method and what will occur upon receipt of the payment by the vendor insofar as the shipping of the product and the verification thereof is concerned. As is indicated at 158, if no alternative method of payment is chosen and the credit card is to be the exclusive method of payment and the vendor 12 does not wish to generate any special e-mail message for the consumer, then the vendor 12 may select by clicking thereon the default online e-mail text content provided and displayed by the computer program to the user/vendor.

The vendor may define a service charge which will be added to the costs of the purchase for any payment method which has been chosen by the consumer including the purchase by utilization of a credit card. This additional service charge can be the amount of the purchase multiplied by a defined percentage or simply a predetermined flat surcharge. This particular charge can be global or defined by payment type and the system automatically calculates the charge such that it will be added to the final amount of the bill before the checkout, such is indicated at 160 in FIG. 7.

The server computer 24 is also programmed to provide an opportunity to the user/vendor 12 to create any new payment method which the vendor 12 wishes to utilize as is indicated at 162. This new payment method can be any desired by the vendor 12 other than those which are presented to the vendor as shown at 148 by a predefined list of payment methods. If such a new payment method is created by the user/vendor then the user/vendor must also create a text which will explain the payment method and the manner in which payment is to be executed as is shown at 164. Also provided as illustrated at 166 is the requirement that the user/vendor 12 generate an e-mail text content which also is an explanation of the payment method. The email is utilized whether the vendor selects the predefined list, utilizes the credit card or creates a new payment method to be sent to the consumer as will be described herein below.

As is also shown in FIG. 7 the vendor is given an opportunity after selecting the billing methods as above described to update the vendor's virtual store as is shown at 168. The store as updated as shown at 170 then contains the vendor's URL as above described. The various products in the store, the layout of the store, and the like. As is also indicated on FIG. 7 at 172 when the consumer checks out with the products which have been purchased from the vendor on the Okaikei.com personalized web site, the handling charge which has been generated as above described in conjunction with the handling charge prompt 160 will be calculated and applied to the sales ticket automatically.

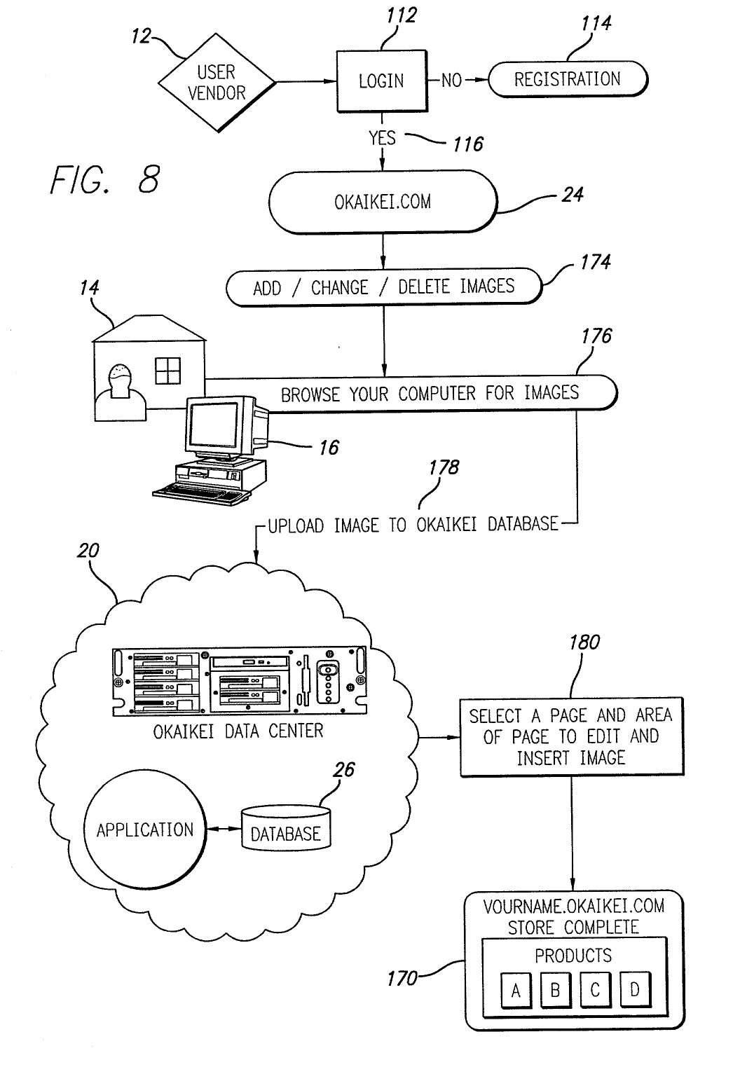

By reference now to FIG. 8, there is illustrated an additional feature which is provided for the vendor 12 to utilize during the store set up as described above in conjunction with FIG. 6. As is therein shown, the vendor 12 can again, login as shown at 112 and if the vendor has not registered then the vendor will be referred to the registration procedure as above described and as illustrated at 114. If registration has occurred as indicated at 116, then the vendor upon login will be directly connected to the server computer 24 as above described. The vendor by way of the server computer 24 being programmed will be presented the opportunity to either add to, to change or to delete images as is illustrated at 174. The utilization of this facility as provided by the program which has been loaded into the server computer 24 allows the user/vendor 12 to select images such as photographs, drawings, montages or the like as may be desired for the purpose of providing a visual effect either of its virtual store or of individual products which are being added to the store. Although the block 174 provides all of the options to either add, change or delete, it is obvious that the user/vendor will select any one of these at any particular point in time. That is, for example, when the user/vendor is setting up a store as described in conjunction with FIG. 6, the user/vendor will select the add feature and click on it. This will then enable the vendor to add to the store and particularly, during the set up of the products any particular image desired. Images will be provided in the database 26,28 which may be searched and used by the vendor 12 if such is desired. If desired, the user/vendor may click onto the change portion and then select a particular image which has already been inserted during the store set up procedure and change that particular image to a different image which may be desired by the vendor 12. Also, if desired, as may occur when a product no longer exists, the vendor may click onto to the delete portion of the option 174 and delete particular images of products which have previously been selected as part of the vendor's virtual store on the Okaikei system.

As is shown at 176, the user/vendor 12 may already have either in its brick and mortar store 14 or alternatively, stored in the memory of its customer client computer 16 photographs, drawings or the like of the products which are to be displayed during the store set up. If these do exist, the option is provided to the vendor 12 to search its own facilities for such images and to then generate them in electronic format in the memory of its computer 16 and then to upload the image as is shown at 178 onto the Okaikei database 26. Once the various images desired to be inserted into the user/vendors 12 virtual store have been selected, the user may then by way of the program resident in the computer server 24 select a particular page of its web site as shown at 180 and the particular area of the page in which the image is to be edited or inserted. Once such has been done and the newly edited material approved by the vendor, it will be inserted into the store 170 as above described and will become part of the vendor's Okaikei.com complete store.

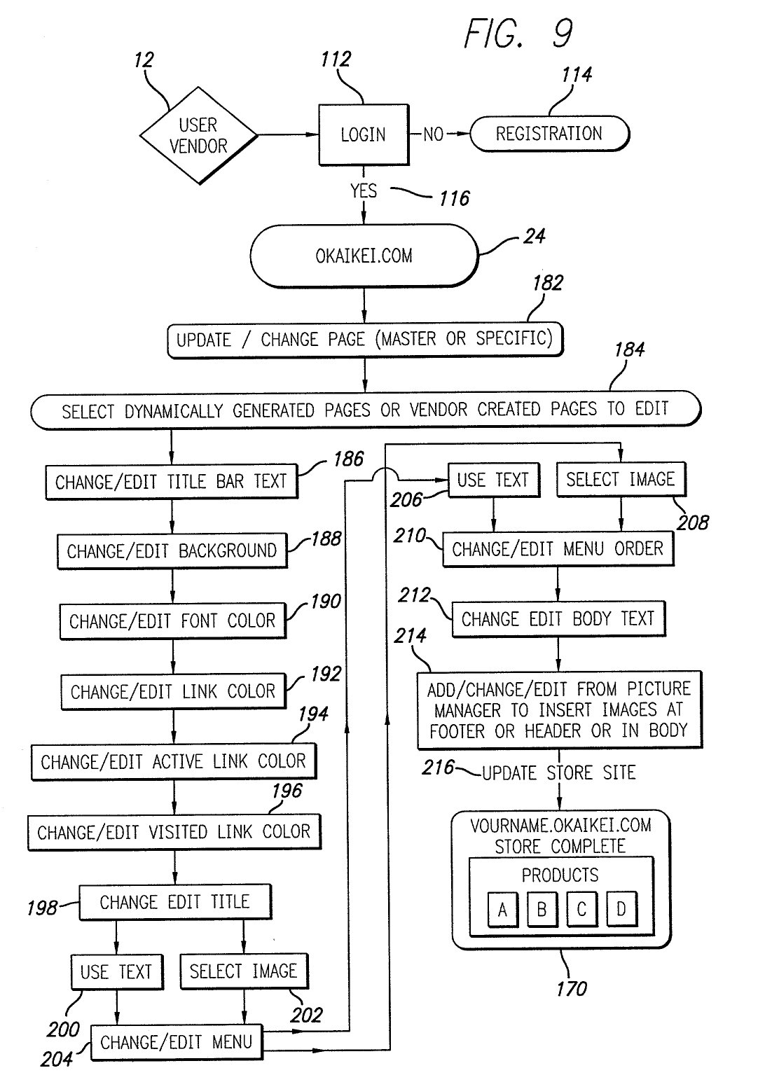

As shown more specifically in FIG. 9, once a particular page has been selected as shown at 180, various options are provided to the user/vendor 12 to assist in editing the particular page. As is shown in FIG. 9, the user/vendor 12 may login as shown at 112 and if not registered will be referred to the registration procedure 114. If already registered as indicated in 116, then upon login the user/vendor will automatically be connected to the Okaikei server computer 24 which has been programmed to present to the user/vendor the ability to update or change a particular page in its web site resident in the Okaikei system as is illustrated at 182. As is shown at 184, the user/vendor 12 will have an opportunity to create its own pages and edit them prior to them being inserted as part of the virtual store or alternatively, may utilize prompts provided by the computer program resident in the server computer 24 to dynamically generate its own web page. It is an important feature of the present invention that the vendor does not have to have knowledge of HTML or any other programming language in order to generate its own web page. The vendor 12 will be provided by the programmed computer 24, PDF instructions in the form of a series of prompts and queries which the vendor 12 may follow on a routine basis by simply reading the prompt or query and responding thereto utilizing the written language of the community in which the vendor resides, such as English, Japanese or the like to create its own web page or virtual store. For example, as is illustrated at 186 the vendor 12 will be presented a title bar and can insert into the title bar the text which is desired by the vendor with respect to the particular item which is being shown. That text can then be changed or edited as desired by the user/vendor 12 using plain language. When the title bar text is finally completed to the satisfaction of the vendor 12, the vendor will then click on “next” and will be directed to the option as shown at 188 to change or edit the background for the particular item which is being worked on. Next in line as shown at 190 would be the ability for the vendor 12 to change or edit the color of the font which is utilized to generate the text on the page. As shown at 192, the option would then be provided to the vendor to change or edit the link color which is being utilized. Likewise, at 194 the ability to change or edit the active link color would be provided and 196 the ability to change or edit a visited link color. After these various options are provided and the changing or editing as desired by the vendor 12 has been accomplished, the vendor would then be provided as shown at 198 the ability to change or edit the title for that particular page. Once all of the additional activities have been complied with during the process of dynamically generating that particular page of the web site, the vendor would then be given an opportunity as shown at 200 to use the text which has been generated or the default text which has been provided by the computer program. In addition, as is shown at 202, the vendor 12 would be provided with the ability to select images which are resident in the Okaikei database. Once the text and the images are selected, they would then be placed into position on the web page which is being dynamically created. The vendor would then be given the opportunity as shown at 204 to change or edit the menu and thereafter, to again use text as is shown at 206 or select additional images as shown at 208. Again, the menu order may be changed or edited as shown at 210. Thereafter, the text which appears in the body of the web page may be changed or edited as is shown at 212.

It should be recognized from the plurality of different prompts and queries above described that the user/vendor 12 is interacting on an active basis with the programmed server computer 24 in the Okaikei system and by doing so, is dynamically generating its own web page by selecting text, color, font, background, images, and the like and being provided with the ability to change or edit those as desired so that a personalized web page is being created by the vendor 12 in a very short period of time and without the necessity of having any understanding of HTML or other programming language normally required to create web pages.

As indicated at 214, once the various features as above described have been selected by the user vendor 12, then the vendor is given the opportunity as above described with respect to the selected image 202 to change or edit those images selected from the Okaikei database. Additionally, the user/vendor may now select the particular areas in the web page which it desires to receive the images that have been selected. That is, the image may go in at any particular spot in the web page that may be desired in order to provide the visual perception which the vendor 12 wishes to project to the consumer. Once the complete editing has occurred with regard to the page and such is to the satisfaction of the vendor, then the virtual store site may be updated as indicated at 216 so that the complete store of “yourname.Okaikei.com” is shown at 170 will have the selected ingredients most desired by the vendor 12.

One of the features which is provided by the Okaikei system is to acquire and store a large amount of detailed information with regard to the activities which occur with respect to each of its vendors' web sites. That is, as indicated at 220 on FIG. 10, the Okaikei database has the ability in its memory to store every transaction which occurs with respect to each individual vendors' web site. For example, as shown at 222, all sales orders which are generated by a particular customer can be tracked and that information stored within the database. Such tracking would obviously occur with regard to the identity of the customer which would be given at the time the customer registers in the Okaikei system as will described hereinafter. In addition thereto, as shown at 224, on FIG. 10, the system may track the hits for the vendors' web site by the Internet addresses of each of the customers which log on to the system and request access to that particular vendor's web site. This traffic may also be tracked according to the date and the dates over a particular range or period of time as is shown at 226. In some instances, the customer is requested at the time of the customers logon to identify anyone who may have referred that customer to this particular website. The system is adapted to track the traffic which occurs by reference to the person who has referred that customer. All of this information along with many other types of information such as the volume of sales, the taxes paid, returns, dissatisfaction and the like, all of which can be stored in the database indicated at 220 may be utilized to allow the vendor 12 to obtain reports as shown at 230 upon demand from the system. As is the case in the past, the vendor 12 would login as shown at 112 and if not registered, would be referred to the registration procedures 114 as above described. If the vendor has already registered then, as is shown at 116, the vendor would be automatically connected to the server computer 24 as shown. The vendor then may select any reports 230 which the vendor 12 may desire based upon various criteria which will be provided by a program resident in the computer server 24 when the reports section is clicked on by the user/vendor 12. That is, a menu of various reports would be provided for the vendor 12 to select from and this menu of reports would generate reports based upon the data which has been stored with regard to the transactions as indicated at 220.

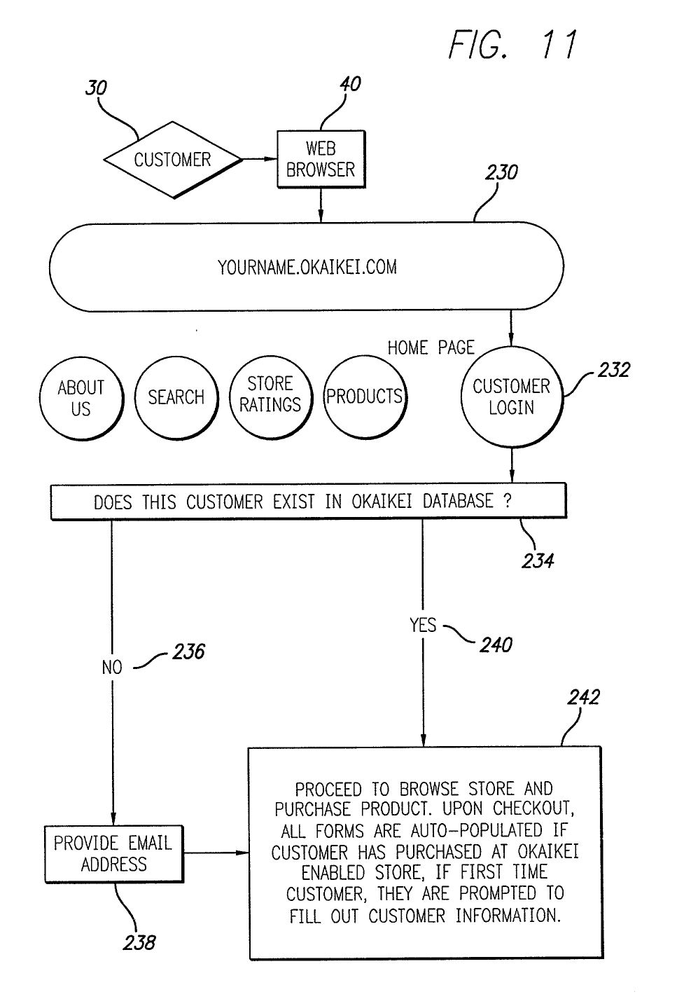

By referring now more specifically to FIGS. 11-17, there is schematically illustrated various features of the vendor's web site which will be viewed by the customer including the manner in which the customer logs in, accesses the various parts of the specific “yourname.Okaikei.com” and has provided to him or her certain options. For example, the customer after logging in may obtain information about the store by clicking onto the “About Us” button, may search the web page to determine what may be available as a result of a query which is of interest to the customer by clicking onto the “search” button, may obtain information about the products on the web page by simply clicking onto the “products” button and may rate the store by clicking on the “store ratings” button. These various features will be dealt with one at a time by reference to each of the FIGS. 11-17 as specified below.

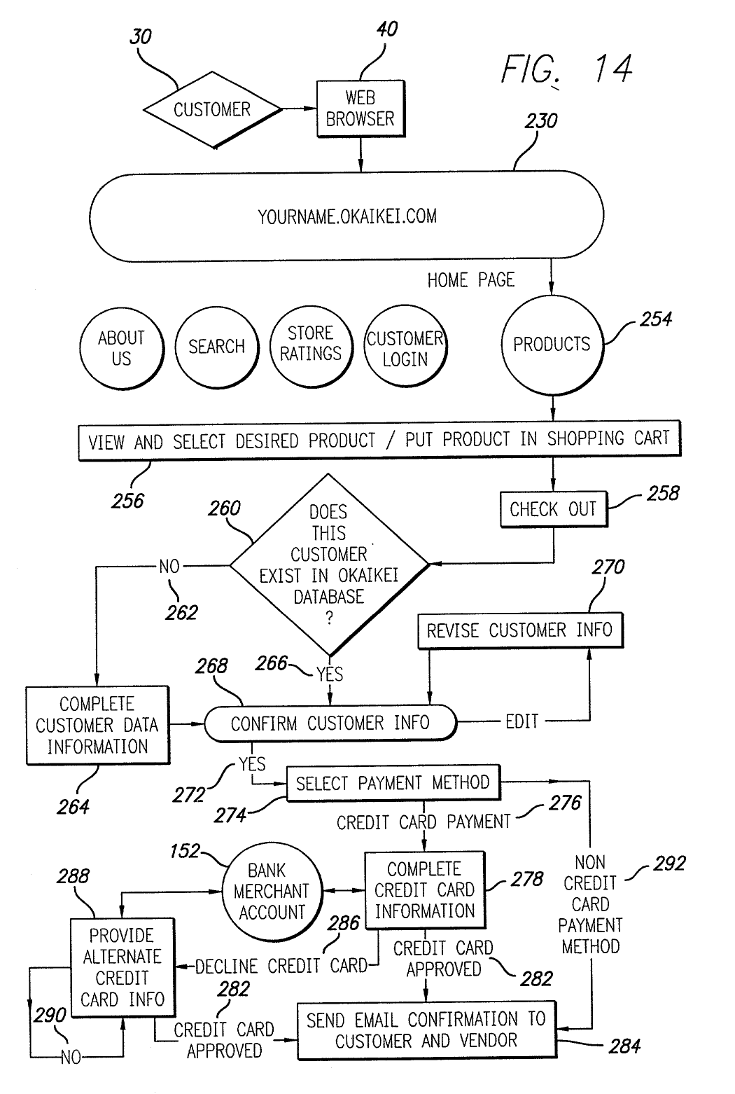

As above indicated during the discussion of the schematic illustration of FIG. 1, the customer 30 may utilize the web browser 40 in his or her customer client computer to access the Okaikei system. This can be done simply by having the name of the particular merchant and then after access to the internet 10 type in the “yourname.Okaikei.com” which will through the manner in which the server computer 24 of the Okaikei system is programmed directly access that particular vendor's web page. Such is illustrated in FIG. 11 at 230. The customer may, however, browse the site without login or registration. If the customer wishes to forward the page to a friend or e-mail the vendor, the customer must provide its e-mail address. When the customer wishes to make a purchase, then the customer is required to go through a full registration procedure. As is illustrated in FIG. 1 the customer 30 will be required to login before being provided access to any of the additional options which may be available. This can be accomplished by the customer clicking onto the customer “login” button 232 which will immediately query the database as to whether or not this customer exists in the Okaikei database as shown at 234. If the customer does not exist as illustrated at 236, then the customer is requested to provide its e-mail address as illustrated at 238. If the customer does exist in the Okaikei database as indicated at 240 or after the customer has provided the e-mail address as shown at 238, the customer is then provided access as shown at 242 to the virtual store of this particular vendor and is permitted to proceed to browse the store and select products for purchasing as desired. If the customer is a first time customer, then they will be required to fill-out the customer information as will be discussed more fully with regard to FIG. 14. As will further be described also if the customer has previously purchased at an Okaikei.com enabled virtual store, then the customer will then be automatically approved and will be allowed to enter the virtual store as selected and purchase products therefrom without again filling out a registration form.

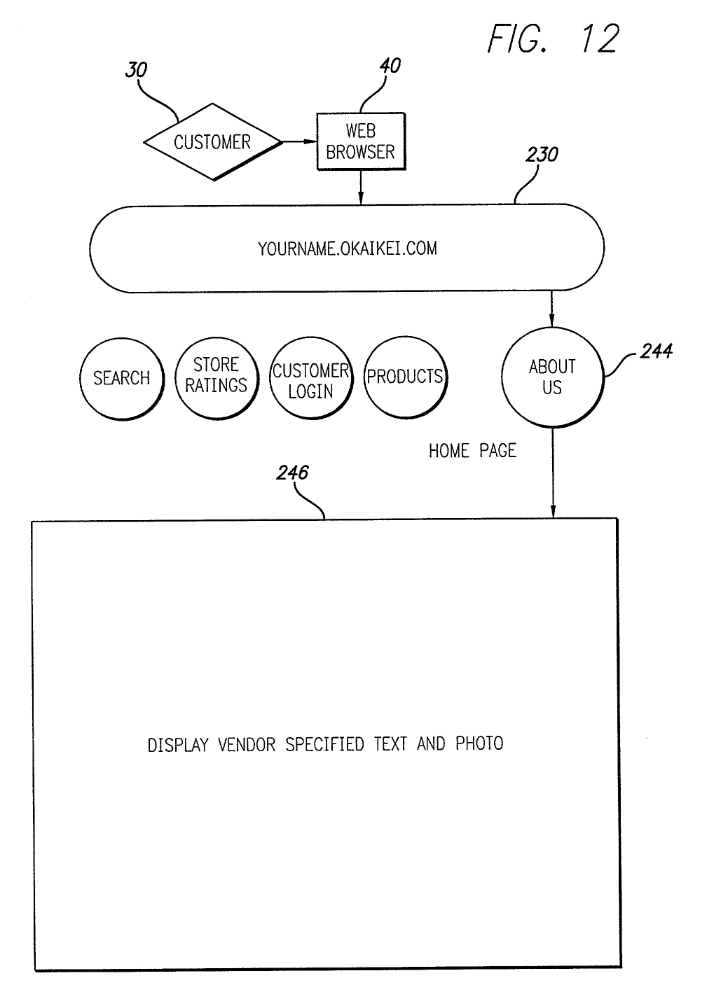

As shown at FIG. 12, to which reference is hereby made, if the customer wishes information about the store 230 which has been accessed, the customer may click on the “About Us” button 244 which will immediately display to the customer on the customers PC's screen that specified text and images selected by the vendor/user 12 when the page was dynamically generated which described the store and as above generally discussed in conjunction with FIG. 9. The information displayed may be any that is desired by the vendor but typically will be a general discussion of the store, its products, its manager, its policies, pricing, discounts and the like which may be of interest to the customer 30 and which the vendor believes will entice the customer to purchase products.

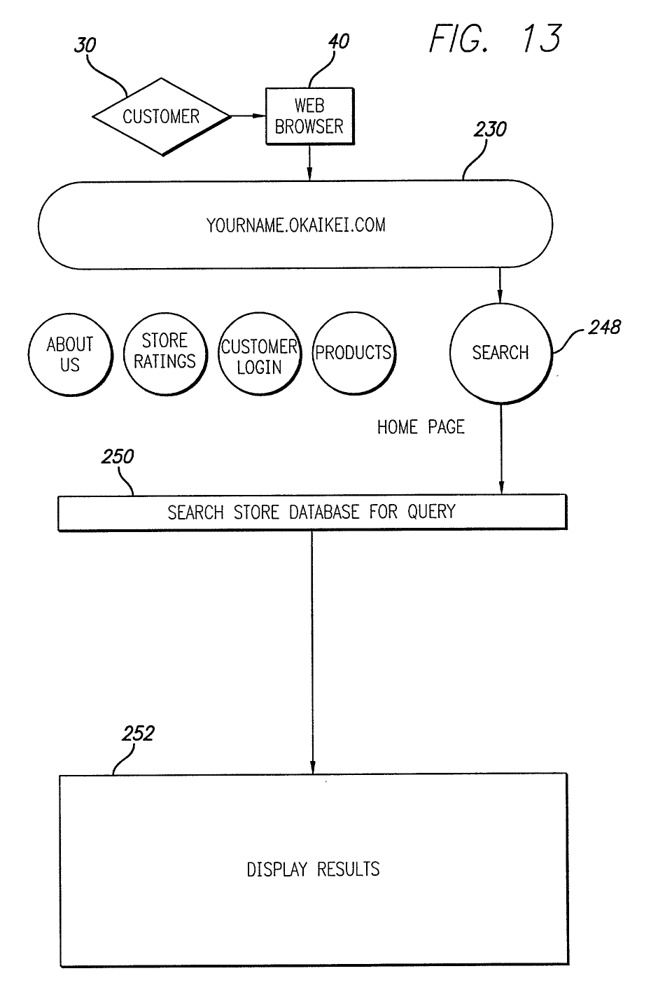

As is illustrated in FIG. 13 to which reference is hereby made, the customer 30 once it has logged in to the desired “yourname.Okaikei.com” virtual store may wish to know whether or not the virtual store carries a product or a product category of interest to the customer 30. Under such circumstances, the customer 30 may click on the “search” button 248 after which the customer will have an opportunity, as a result of the manner in which the server computer 24 is programmed, to enter into the material presented on the customers PC screen a particular query regarding the desired product or product category and instruct the computer to search the store database as illustrated at 250 to determine whether or not that product or product category exists in that virtual store. Upon a search of the database, the results obtained from the search are then displayed as illustrated at 252 on the customers screen. After this display, the customer can then decide whether to further investigate the products to determine whether or not he/she wishes to purchase the same.

As is illustrated in FIG. 14, the customer after logging into the store 230 and desiring to determine whether or not to purchase from that store may click on the “products” button 254. This will provide on the customers screen web pages or portions thereof which were dynamically created by the vendor 12 as described above in conjunction with FIGS. 6 and 9 when the store was set up and various of the products were selected to be placed in the store at various positions. This will enable the customer to view these various portions of the web page as illustrated at 256. When the customer has found a product which he/she wishes to purchase, that product may be placed in the customer's shopping cart. As above described, the Okaikei system includes shopping cart technology as an integral part thereof. The customer may browse through the entire store and view any or all of the products and select those products which the customer desires to purchase by placing them in the shopping cart utilizing the shopping cart technology as is well known to those skilled in the art. When the customer has completed viewing the products and has selected those products which it wishes to purchase, the customer may then click onto the “checkout” button as shown at 258. This will indicate to the server computer that the customer has completed selecting products and now wishes to go through the process of paying for those purchases. The Okaikei database will be queried as shown at 260 to determine whether or not the customer exists in the Okaikei database. If the answer to the query is that the customer does not exist in the Okaikei database as indicated at 262, the customer will then be required to complete a customer data information form as shown at 264. That customer information data form will appear on the screen of the customer client computer and the customer will be required to insert such information thereon. The Okaikei system requires, for example, such information as the customer's e-mail address, credit card data, and the like, such information, as indicated at 266 on FIG. 2 will then be inserted into the Okaikei database 26, 28 where it is stored for future access and utilization. If the customer, upon the query 260, does exist in the Okaikei database as indicated at 266, then the customers information is confirmed by displaying the same on the customers PC screen as shown at 268 with a query to the customer as to whether or not the information which appears thereon and which has been retrieved from the Okaikei database is correct. If the customer determines that information as it appears is incorrect or has been changed, then the customer is given the opportunity as shown at 270 to edit or revise that customer information until it is, in fact, correct. Once the customer information is correct as indicated at 272, the customer is then given the option of selecting the payment method for the goods as shown at 274. If the payment is to be made by credit card as indicated at 276, then the customer is required as shown at 278 to complete the credit card information. As above indicated, the utilization of the credit card is the preferred method for completing the transaction in the Okaikei system. Once the credit card information such as the issuer, the card number, and expiration date or the like have been completed by filling in the desired information on the customers PC screen and such is completed, the customer will then click on the “submit” button and the information regarding the credit card will be automatically transmitted to the bank merchant account 152. BEA then processes that credit card information to obtain authorization to charge the credit card from the bank 280 which has issued the customers credit card. If the credit card is approved as shown at 282, then the server computer 24 is programmed to automatically send an e-mail as shown at 284 to the customer and to the vendor whose virtual store the customer has completed the purchase at and confirming that the purchase has been requested by the consumer. After confirming that the goods ordered are available, the vendor then clicks to settle the payment for the purchase. As above discussed, the consumer credit card information, though stored in the Okaikei database, is not accessible by the vendor. At this point, the purchase amount is charged against the card and is processed for settlement by the bank.

If, however, the vendor's bank declines the credit card as indicated at 286, then the customer 30 is requested to provide alternate credit card information as shown at 288. Once the alternate credit card information, such as a different card issued by the same or a different bank has been provided, the “submit” button will again be clicked on by the customer and this information will be submitted to the bank merchant account 152 requesting approval. If the credit card is approved, then the e-mail as above referred to is forwarded. If not, as indicated at 290, then the sale cannot be completed and the customer and the vendor will be so notified.

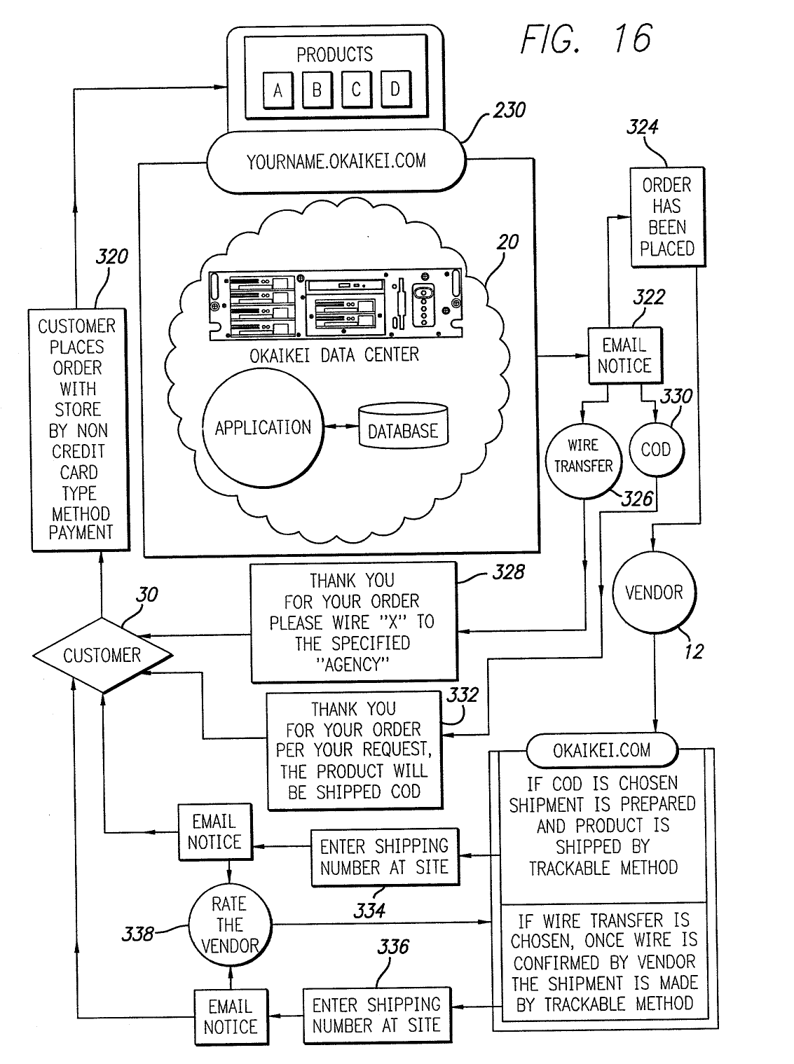

As indicated at 292, when the select payment option 274 is made available to the customer, the customer may select a non-credit card payment method. As above discussed in conjunction with FIG. 7, that payment method may be one from a predefined list of selected payment methods other than credit cards or may be a different new payment method which is created by the user/vendor. Under such circumstances as above described, the conditions and procedures established by the vendor will be followed with regard to such payment procedures and such will be discussed in greater detail with regard to FIG. 16.

As shown on FIG. 15 to which reference is hereby made, if the customer 30 after login into “yourname.Okaikei.com” virtual store as shown at 230, and selects desired products and puts the products in a shopping cart and then elects to check out as discussed above in conjunction with FIG. 14, then the customer may then checkout and pay for the purchases with a credit card. The Okaikei system 20 is programmed through the server computer 24 to automatically issue an e-mail notice 294 which will be transmitted as shown at 296 to the customer 30 thanking the customer for the order which has been placed by the customer with the store and also, informing the customer that a particular amount of money calculated in accordance with the product shown and any handling, taxes or other charges which were automatically tallied with the order has been placed as a hold against the customer's credit card that is a “block” for that amount has been placed against the credit card. Simultaneously, the email 294 will include a notice to the vendor as shown at 298 that an order has been placed identifying what the products are. The vendor upon receipt of the notice that the order has been placed will prepare the order in accordance with the procedures established by the Okaikei system and will ship the product in accordance with pre-agreed upon shipping instructions by a method which can be tracked as is illustrated at 300 in the FIG. 15. When that information is provided to the Okaikei system it will automatically be entered into the database as shown at 302 and the computer as programmed will generate an e-mail notice as shown at 304 that the order has been shipped as indicated at 306 and this e-mail will be transmitted to the customer 30 providing the information regarding the tracking data for the product. In accordance with the Okaikei system computer program, the information provided to the customer will also indicate that the customer may accept the shipment by clicking onto the “accept” button 308 or may decline the shipment by clicking onto the “decline” button 310 and will be further notified by one or more e-mails that in the event that there is no action taken to accept or decline, that the shipment will be deemed accepted automatically within some predetermined period of time, such as thirty (30) days. When acceptance of the shipment has occurred as is indicated at 312, the Okaikei.com system will be notified at which time payment will be made to the Okaikei.com bank account and subsequently by the Okaikei system to the vendor as indicated at 314. If the shipment is declined by activating the decline button 310 then that information will be transmitted as illustrated at 316 to the Okaikei system and arrangements will be required between the vendor and the customer for the merchandise to be shipped and picked up.

As is also indicated, the customer is given the opportunity to rate the vendor if the customer decides to do so. This may be accomplished by the customer clicking onto the “rate the vendor” button 318 and will then on the screen of the customer client computer have an opportunity to make any comments desired that would provide feedback to the store which information would be stored in the Okaikei database.

By reference now to FIG. 16, there is schematically illustrated a purchase of a product by a customer when the customer uses a type of payment other than a credit card. As is therein shown, the customer 30 logs in to the “yourname.OKAIKEI.com” store as shown at 230 and is properly recognized as a customer existing in the database. The customer browses through the store looking at the website, clicks onto the products, makes the determination that one or more products is to be purchased, places those in the shopping cart and then checks out. On the checkout, the customer elects one of the payment systems from the predefined set or the new payment method created by the vendor as discussed in conjunction with FIG. 7 and as specified at 292 in FIG. 14 such is indicated on FIG. 16 at 320. When such occurs, the Okaikei system 20 through the programmed server computer generates an e-mail notice as indicated at 322 which notifies the vendor 12 that an order has been placed as indicated at 324. At the same time, the e-mail notice is returned to the customer and if a wire transfer form of payment has been selected as indicated at 326, the Okaikei server computer is programmed to generate e-mail thanking the customer for the order and directs the customer to wire transfer to a specified agency that is defined by the vendor as is indicated at 328. On the other hand, if the customer has chosen a collect on delivery type of payment as indicated at 330, the e-mail generated by the computer again thanks the customer for the order and advises the customer that the products will be shipped by the vendor, collect on delivery as indicated at 332.

As above indicated with regard to the purchases made and illustrated in FIG. 15, when the vendor is notified that the order has been placed and the manner of payment that has been chosen, either wire transfer or C.O.D., then through the Okaikei system the vendor chooses the shipment required and does so by a method which can be tracked. This is done whether it is C.O.D. or wire transfer. In either event, the shipping information is generated for C.O.D. as shown at 334 and 336 such that the shipping information is entered into the database and an email is generated in each instance notifying the customer regarding the shipping information. The customer upon receipt of this information may then, if desired, rate the vendor as indicated at 338 by clicking onto the “rate the vendor” button and placing any information desired that may be beneficial to the vendor on the vendor's web site on the “my account” page and such will be stored in the Okaikei database.

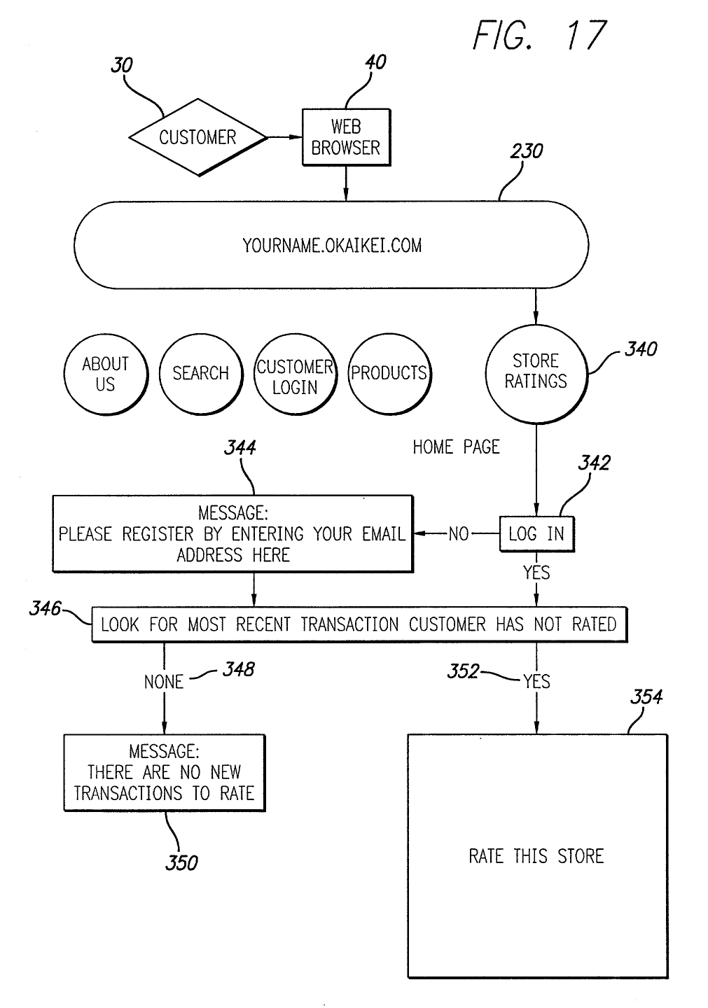

In some instances, the customer may desire to rate the store and if so, as indicated in FIG. 17, the customer 30 may through his or her web browser 40 logon to the store 230 and click the “'store ratings” button 340. The program computer will then determine, when the customer logs in as shown at 342, whether or not the customer has previously registered with the Okaikei system. If the customer has not registered, then the customer will be told by a prompt on the screen as shown at 344 to register by entering his or her e-mail address. When such has occurred or if the customer has previously registered then the computer program will look for the most recent transaction by that customer which did not result in any rating by the customer. If there are none as indicated at 348, the customer will be given a message that there are no new transactions to rate and the ability to rate the store will be denied. On the other hand, if the search of the database discloses that there are earlier transactions which the customer did not rate as shown at 352, the customer will then be given access to the database and told to rate the store as indicated at 354. Under these circumstances, this rating will then be recorded on the store web site and also will be forwarded to the database. It is important to note that there can be only one rating per transaction and that no ratings can be entered without a completed transaction. This prevents a merchant from generating ratings of his store and posting them to influence customers.

Referring now, more specifically, to FIG. 2, it will be recognized from the above discussion that when the customer 30 has logged into the store after it has been setup and has made the purchase and has specified the manner of payment as indicated, the system will notify the merchant of the order and a shipping notice is forwarded to the customer by e-mail as indicated at 356 and the user has confirmed delivery of the product as shown at 358, then payment will be made as indicated at 360.

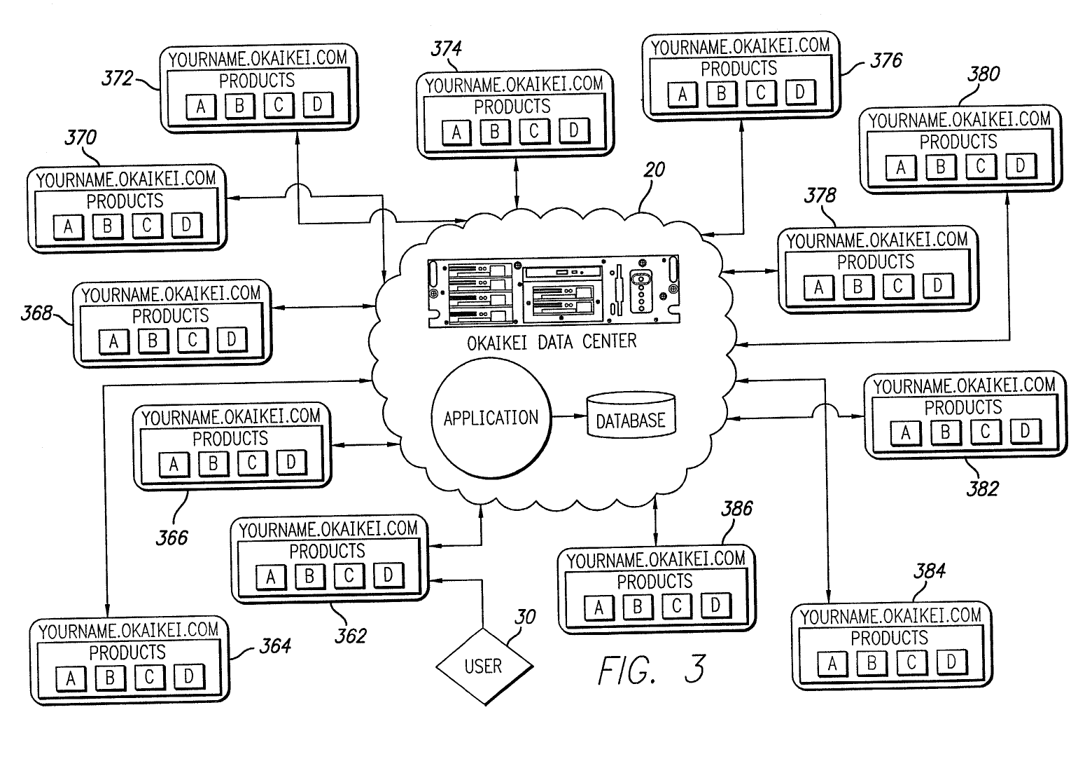

As above indicated, although the description thus far has been generated with regard to a single vendor merchant setting up its virtual store on the Okaikei system under its “yourname.OKAIKEI.com” unique URL, it is contemplated that there will be a multiplicity of such merchants who will subscribe to the Okaikei system and will dynamically generate their web pages as above described. When such is done, each of these merchants will be logged into the Okaikei system. Such is schematically illustrated in FIG. 3 to which reference is hereby made. As is therein shown, there are independent vendors 362 through 386 each of which has registered with the Okaikei system and has selected their unique URL's and have generated a virtual store by following the setup procedures and by generating dynamically their web pages such that they are resident in the database of the Okaikei system 20 as is shown. Under these circumstances, a customer 30 may access the Okaikei system and type in the URL of any one of the stores 362 through 386 and be connected to that virtual store of that vendor. Although a limited number, namely 362 through 386, of vendors is shown in FIG. 3 it will be recognized by those skilled in the art that the number of such vendors which may be registered and whose virtual stores will be resident in the database of the Okaikei system 20 is virtually unlimited as to type and number.

One of the unique aspects of the Okaikei system is that once a customer has logged onto the Okaikei system and has filled out the customer information including that required to have approval of the credit card information as shown and described with respect to FIG. 14, then the customer 30 can access any of the registered vendors through the Okaikei database. Since the customer has already registered and has its credit card information resident in the Okaikei database and approved, the customer will not have to fill out any additional order forms even though the user has never visited the specific virtual store now desired. That is, a single registration with one Okaikei virtual store functions as a global registration for all of the Okakei virtual stores. This unique aspect of the Okaikei system makes the system much more user friendly and much more acceptable for the customers.

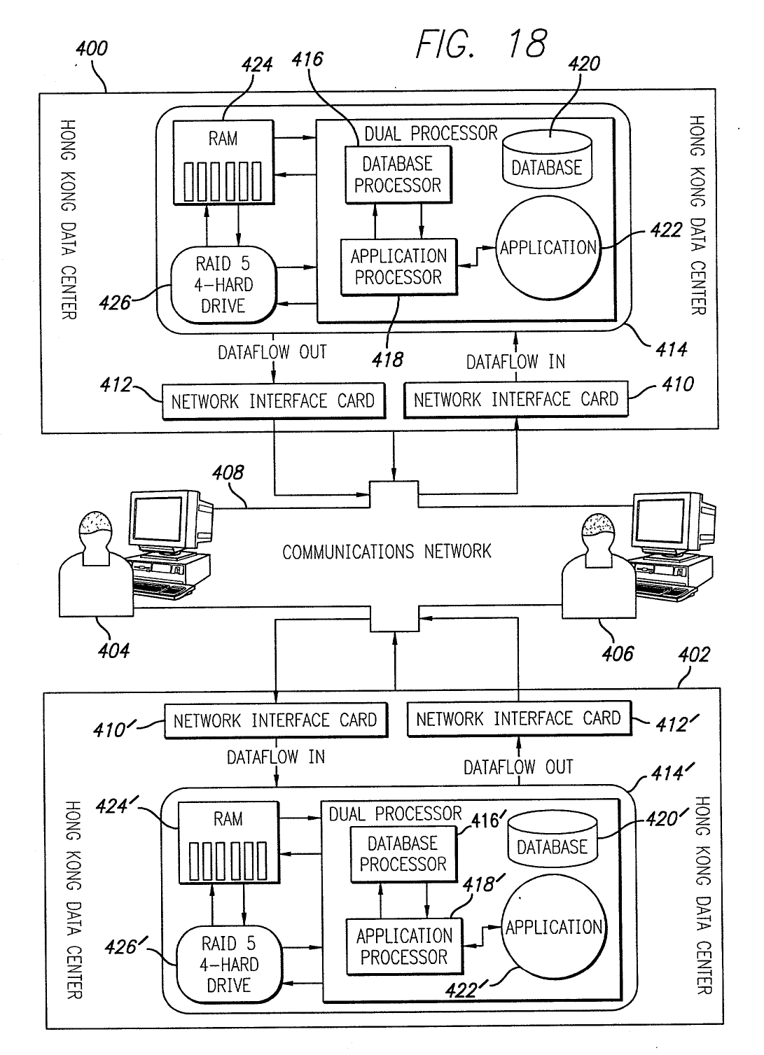

An overall system constructed in accordance with the principles of the present invention is illustrated schematically in FIG. 18. As is therein shown, the system may be mirrored into different places as indicated at 400 in a Hong Kong data center and at 402 in a Los Angeles data center. By such mirroring, it will enable the system to efficiently operate irrespective of the number of vendors and customers which may be on the system at any one point in time or in the event of a failure at either of the data centers the other can immediately pick up the load and continue to function. Thus, it will be transparent to the users whether they be vendors or customers, as to where the actual data processing is occurring. As is shown, vendors 404 or customers 406 may access the system through the utilization of a communications network 408 which may be either through a wireless system or alternatively, a LAN line telephone system such as a POTS as is well known to those skilled in the art. The data flow between those accessing the system whether a vendor or a customer will be through appropriate network interface cards 410 and 412 for data flow entering the Okaikei system 414 or flowing out of the system 414, respectively. Thus, there is two way communication between the users and the system through the communication network as above described in conjunction with the preceding drawings. As is illustrated on FIG. 18, the Okaikei system 414 includes an appropriate computer or database processor 416, an application processor 418, an appropriate database 420 and an application program 422. The processor includes random access memory 424 and a hard drive 426 which is controlled to provide appropriate operation of the system. As above indicated, the Los Angeles data center will be an exact mirror of the Hong Kong data center and a result, the same numerals are utilized primed for the identical portions of the system. It should be recognized by those skilled in the art that although the Okaikei system is shown in a mirrored format in FIG. 18, such is not required. That is, the system may include a single data center or may include a multiplicity of data centers, more than two, as illustrated in FIG. 18 depending upon the number of participants in the Okaikei system.

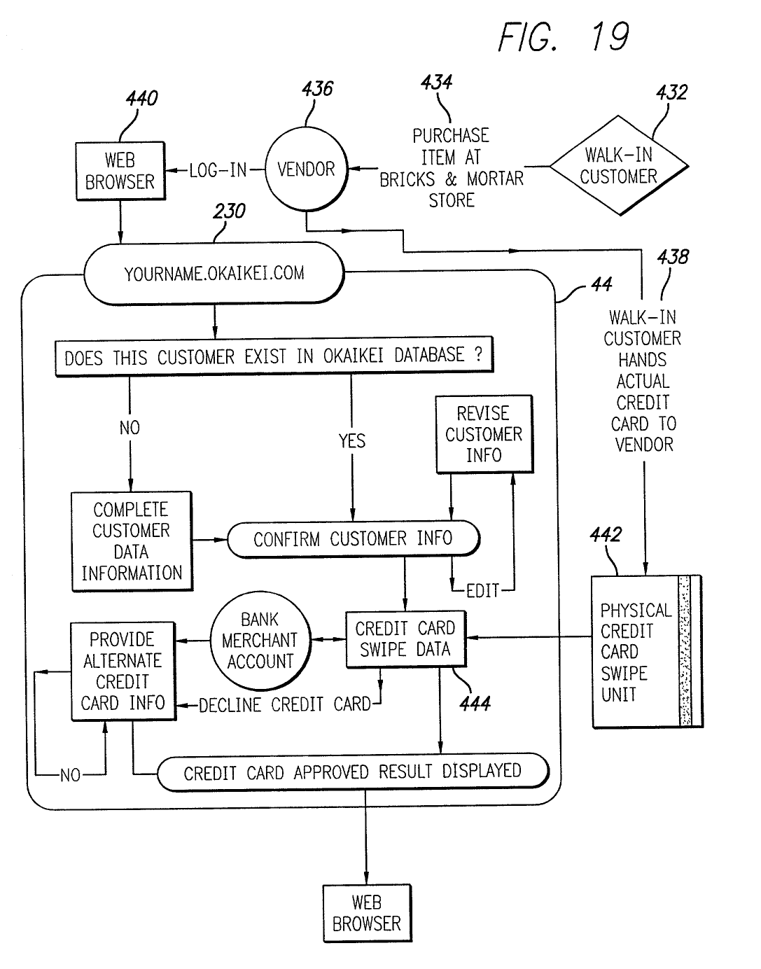

As described in the introductory portion of the specification, in some instances it is difficult or extremely expensive for a merchant to qualify for credit card purchases by its customers. To provide the convenience for walk-in customers to utilize credit cards with a vendor which does not have the typical facilities for qualifying for credit card purchases, the Okaikei system provides a virtual terminal for such purposes as is shown generally at 430 on FIG. 2. Thus, if a user 30 wishes to make a credit card purchase, the Okaikei merchant or vendor 12 through utilization of the Okaikei system may accept the users credit card as long as the vendor is properly registered with the Okaikei system as generally described above. This activity is illustrated more in detail at FIG. 19 to which reference is hereby made. As is therein shown, a walk-in customer 432 goes into the bricks and mortar store 434 of a vendor 436 who has registered with the Okaikei system. Once the walk-in customer selects the products which it wishes to purchase at the bricks and mortar store, the walk-in customer provides to vendor 436 the credit card as shown 438. The vendor 436 utilizes its web browser 440 to login to the Okaikei system and to the vendor's virtual store 230. The only requirement is that the vendor has a physical credit card swipe unit as shown at 442. The vendor then swipes the customer's credit card through the card swipe unit 442 and that information is inserted into the Okaikei system 44 as illustrated at 444. The system is programmed and functions as described in conjunction with the description of FIG. 14 to confirm the customers existence and information and to provide, through the bank merchant account, approval of the credit card purchase by the bank which has issued the credit card. If the credit card is approved, then that result is displayed through the merchant's web browser onto the vendor client computer screen thus, allowing the walk-in customer to complete the purchase and depart the store with the goods with the vendor being assured that the goods have been paid for by the credit card. As a result of this facility, the vendor at its bricks and mortar store does not have to have the expenditure required to qualify for credit card purchases by its customers but rather can utilize the Okaikei system and the fact that its operations are guaranteed by a financial institution such as the Bank of East Asia as shown at 154 in FIG. 2 to accommodate the vendor and its walk-in customers.

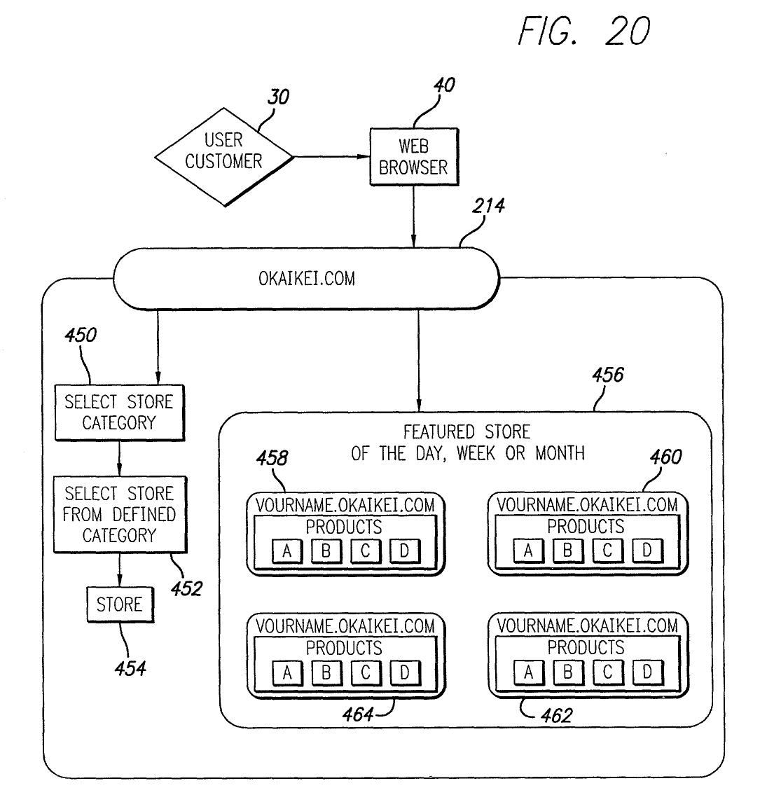

The Okaikei system is also designed and programmed in such a way that a customer 30 through his or her web browser 40 may access the Okaikei.com server computer 24 and insert a query according to categories of products desired. As shown at 450, a number of different stores meeting this category is shown at 452 and the customer can select a particular store as illustrated at 454 from those stores which meet the defined category inserted by the customer. When the store is selected, then the server computer 24 is programmed in such a way as to provide immediate access by the customer 30 to the virtual store 454 which has been selected. In addition, a customer may by logging into the Okaikei.com computer server be provided on the screen with an option to view the featured store of the day, week or month as is illustrated at 456. Under such circumstances, that store will be identified by its URL and by a presentation of a homepage through the customers browser onto its PC screen. For example, illustrating the feature stores 458 through 464 as shown at FIG. 20, the customer 30 may then by clicking onto any one of these featured stores be connected to that store's web page.

There has thus been disclosed a full service e-commerce enablement system for small and medium size businesses to enable them to provide an affordable, complete, real time, one-stop, online credit/debit card processing dynamic transactional analysis, database management, and a fully functional online shopping cart system for the vendor's customer base.

What is claimed is:

1. A network merchandising system for enabling the small business vendor to establish and operate a virtual store without having access to or knowledge of html or other programing language comprising:
a server computer;
a database operatively connected to said server computer;
at least one vendor client computer;
a least one customer client computer;
a network operatively interconnecting said server computer, said at least one vendor client computer and said at least one customer client computer;
said server computer programmed to provide to said at least one vendor client computer a first series of instructions for enabling selection of a store name, said store name including a preset required designator; and
said server computer further programmed to provide to said at least one vendor client computer a second series of instructions for enabling set up of said store without said small business vendor using html or other programming language.

2. A network merchandising system as defined in claim 1, wherein said server computer is further programmed to search said database to determine whether or not a desired store name is available for appropriation by said small business vendor.

3. A network merchandising system as defined in claim 2, wherein said second series of instructions includes a virtual store layout.

4. A network merchandising system as defined in claim 3, wherein said second series of instructions includes products setup and instructions.

5. A network merchandising system as defined in claim 4, wherein said server computer is further programmed to require said vendor to establish a credit card vendor account.

6. A network merchandising system as defined in claim 3, wherein said server computer is programmed to permit access to a vendors store resident on said network database by a customer through said at least one customer client computer.

7. A network merchandising system as defined in claim 6, wherein said server computer is further programmed to permit said vendor to provide alternative payment methods which may be selected by said customer to pay for purchases made at said vendor store.

8. A network merchandising system as defined in claim 7, wherein said server computer is further programmed to automatically send e-mails to a customer after said customer has made purchases at said store, said e-mails confirming the purchase and the payment method and providing to the customer a mode of acceptance or rejection of the transaction.

9. A network merchandising system as defined in claim 8, wherein said server computer is further programmed to notify by e-mail said customer that the transaction will be deemed consummated if said customer does not respond to the e-mail within a specified period of time.

10. A network merchandising system as defined in claim 9, wherein said server computer is further programmed to credit said vendors account with payment for purchases made by the customer only after the customer transaction is fully consummated.

11. A network merchandising system as defined in claim 10, wherein said server computer is further programmed to permit a customer to rate said vendors store only once for each transaction consummated and to preclude rating of the store unless a transaction has been consummated.

12. A network merchandising system as defined in claim 3, wherein said second series of instructions includes instructions permitting said vendor to upload images of products from said customer client computer to said database and to then select said images for use in setting up said store.

13. A network merchandising system as defined in claim 12, wherein said database includes images stored therein which may be selected by said vendor in setting up said store.

14. A network merchandising system as defined in claim 13, wherein said server computer is further programmed to permit said vendor to access said vendors store through said vendor client computer to process a credit card purchase through said system by a walk-in customer.

15. A network merchandising system as defined in claim 4, wherein said server computer is further programmed to allow said vendor through said vendor client computer to generate a page providing detailed information about a specific product.

16. A network merchandising system as defined in claim 15, wherein said server computer is further programmed to allow said vendor to highlight at least one specific product as a preferred product.

17. A network merchandising system as defined in claim 6, wherein said server computer is further programmed to track all transactions occurring on said network merchandising system and record same in said database and to provide reports based on said transactions to said vendor on request of said vendor.

18. A network merchandising system as defined in claim 17, wherein said server computer is further programmed to provide reports based on IP addresses of customers.

19. A network merchandising system as defined in claim 17, wherein said server computer is further programmed to provide reports based on a range of dates during which customers logged on to said vendor's store.

20. A network merchandising system as defined in claim 10, wherein said alternative payment methods include credit cards and when said customer selects payment by credit card said server computer is programmed to require said customer to provide credit card information, said credit card information being stored in said database in a manner not accessible to said vendor.

21. A network merchandising system as defined in claim 10, which further includes a multiplicity of vendors registered to use said system and a multiplicity of customers registered for access to said system wherein said server computer is programmed to allow any registered customer access to any vendor store without further registration.

22. A network merchandising system as defined in claim 20, which further includes a single bank merchant account for processing credit card payments, said bank merchant account being accessible to all registered vendors to process credit card purchases by said customers.

23. A network merchandising system as defined in claim 21, wherein said server computer is programmed to allow a customer to search said database by product category and said system identifies all registered vendors having products within said category.

24. A network merchandising system as defined in claim 9, wherein said server computer is programmed to automatically send an e-mail to a customer after an ordered product has been shipped, said e-mail providing product shipping tracking information.

25. A network merchandising system as defined in claim 16, wherein said server computer is programmed to allow said vendor access to said vendors virtual store to edit the content of said virtual store.

26. A network merchandising system for enabling the small business vendor to establish and operate a virtual store without having access to or knowledge of html or other programming language comprising:
a server computer;
a database operatively connected to said server computer;
at least one vendor client computer;
a least one customer client computer;
a network operatively interconnecting said server computer, said at least one vendor client computer and said at least one customer client computer;
said server computer programmed to provide to said at least one vendor client computer a first series of instructions for enabling selection of a store name, said store name including a preset required designator;
said server computer further programmed to provide to said at least one vendor client computer a second series of instructions for enabling set up of said store without said small business vendor using html or other programming language; and
said system including a bank merchant account interconnected to said database for processing credit card purchases by said at least one customer from said at least one vendor virtual store.

27. A network merchandising system as defined in claim 25, wherein said server computer is further programmed to automatically send e-mails to a customer after said customer has made purchases at said store, said e-mails confirming the purchase and the payment method and providing to the customer a mode of acceptance or rejection of the transaction.

28. A network merchandising system as defined in claim 27, which further includes a multiplicity of vendors registered to use said system and a multiplicity of customers registered for access to said system wherein said server computer is programmed to allow any registered customer access to any vendor store without further registration.

29. A network merchandising system as defined in claim 17, wherein said server computer is further programmed to track all transactions occurring on said network merchandising system and record same in said database and to provide reports based on said transactions to said vendor on request of said vendor.
